(19) United States
(12) Patent Application Publication
(10) Pub. No.: US 2026/0071995 A1
(43) Pub. Date: Mar. 12, 2026

(54) ANALYTICAL METHOD FOR CHARACTERIZATION OF RNA IN LIPID NANOPARTICLES

(71) Applicant: Nutcracker Therapeutics, Inc., Emeryville, CA (US)

(72) Inventors: DAVID AKOPIAN, Emeryville, CA (US); ARMONDO HERNANDEZ, Emeryville, CA (US); CHIH-LING CHOU, Emeryville, CA (US)

(21) Appl. No.: 19/391,108

(22) Filed: Nov. 17, 2025

Related U.S. Application Data
(63) Continuation of application No. PCT/US24/30747, filed on May 23, 2024.
(60) Provisional application No. 63/468,623, filed on May 24, 2023.

(51) Int. Cl. G01N 27/447

(52) U.S. Cl. CPC G01N 27/44791

(57) ABSTRACT

Disclosed herein are methods for analyzing a nucleic acid encapsulated in a lipid nanoparticle (LNP). In one aspect, the methods may comprise solubilizing an LNP with a nonionic surfactant to form an analyte sample, introducing the analyte sample into a capillary, and detecting the nucleic acid via capillary electrophoresis (CE). In certain aspects, the nonionic surfactant may comprise from about 1% to about 10% v/v of the analyte sample.

### CROSS-REFERENCE TO RELATED APPLICATIONS

The present application claims the benefit of and priority to U.S. Provisional Application Ser. No. 63/468,623, filed May 24, 2023, the disclosure of which is incorporated herein in its entirety.

### BACKGROUND

Nucleic acid-based therapeutics, for example, mRNA-based therapeutics, use the cell translational machinery of the host to produce a protein or peptide of interest, which in turn produces a therapeutic effect in the host. The efficacy of mRNA vaccines depends on the ability of mRNA to cross the cell membrane in order to reach the cytoplasm, where it can be translated. mRNA delivery strategies include encapsulation in a delivery vehicle, for example a lipid nanoparticle (LNP). Because nucleic acids, mRNA in particular, is susceptible to hydrolysis and subsequent degradation, mRNA stability can pose a challenge and the integrity of a therapeutic containing a nucleic acid should be monitored, not only before encapsulation in a delivery vehicle, but also after the nucleic acid is incorporated into a delivery vehicle to form a drug product (DP). Such monitoring is useful to ensure therapeutic effectiveness and safety of the delivered nucleic acid.

Effective analysis of nucleic acids, such as RNA, encapsulated in lipid nanoparticles is important for ensuring the quality of such products, particularly when used as a therapeutic for human use, as is the case for mRNA-based vaccine formulations and gene delivery products. To evaluate the integrity of the nucleic acid encapsulated in a delivery vehicle, the nucleic acid is ideally separated from the delivery vehicle (de-formulated) prior to being analyzed. Methods of extracting a nucleic acid from a delivery vehicle has been described. For example, organic (phenol: chloroform) extraction methods for RNA isolation have been described. (See, e.g., Vomelová, Z., Methods of RNA purification. All ways (should) lead to Rome, Folia Biol. (Praha), 55 (6) (2009), pp. 243-251). Methods employing guanidinium thiocyanate and β-mercaptoethanol followed by ethanol extraction or ultracentrifugation in cesium chloride gradient have also been used. (See, e.g., J. M. Chirgwin, et al., Isolation of biologically active ribonucleic acid from sources enriched in ribonuclease, Biochemistry, 18 (24) (1979), pp. 5294-5299, 10.1021/bi00591a005.) Further methods proposed to address this need have included precipitation of ribonucleic acid using ammonium acetate in combination with ethanol or isopropanol. (See, e.g., H. H. Osterburg, J. K. Allen, C. E. Finch, The use of ammonium acetate in the precipitation of ribonucleic acid, Biochem. J., 147 (2) (1975), pp. 367-368, 10.1042/bj1470367.) More recently, single step mRNA extraction techniques using the guanidinium thiocyanate phenol-chloroform extraction method have been used (See, e.g., P. Chomczynski, N. Sacchi The single-step method of RNA isolation by acid guanidinium thiocyanate-phenol-chloroform extraction: twenty-something years on, Nat. Protoc., 1 (2) (2006), pp. 581-585, 10.1038/nprot.2006.83.) In addition, spin column and magnetic particles-based methods have been used for extracting nucleic acids from different biological samples. Commercially available spin column kits for nucleic acid extraction include silica membrane, anion exchange, filter paper, glass fiber, and polyethylene fibers, while commercially available magnetic particles include silica, porous glass, cellulose, agarose, polystyrene, and silane. More recently, Brij® 58 in formamide was also used for extracting RNA from mRNA-LNPs. (See generally: Malburet et al., mRNA extraction from lipid nanoparticles, Journal of Chromatography A, Volume 1714, 2024, 464545, ISSN 0021-9673, https://doi.org/10.1016/j.chroma.2023.464545.)

In general, currently available methods of analyzing the nucleic acid of a drug product require both a de-formulation step, in which the nucleic acid is separated from the delivery vehicle, and a “clean-up” step, in which the delivery vehicle (for example a lipid nanoparticle) is separated from the nucleic acid. Such clean-up methods include, for example, lithium chloride precipitation or purification via column separation, which removes the nucleic acid from the de-formulated composition for analysis. However, while the nucleic acid can be analyzed, clean up methods which remove portions of the sample following de-formulation also removes impurities that may be desirable to include in the composition for evaluation, as it can be essential to detect and measure both the therapeutic nucleic acid and any contaminants.

Thus, while methods to extract nucleic acids from delivery vehicles, are known, there is a need for improved methods (e.g., de-formulation methods) that allow for resolution of one or more nucleic acids encapsulated in a delivery vehicle. There is further a need for methods for analyzing delivery vehicles comprising a nucleic acid which do not require a clean-up step. Yet further, there is a need for de-formulation methods that do not remove impurities/contaminants or nucleic acid fragments, and which allow for detection of any such contaminants in the drug product. The instant disclosure seeks to address one or more of the aforementioned needs in the art.

### BRIEF SUMMARY

Disclosed herein are methods for analyzing a nucleic acid (e.g., a therapeutic nucleic acid or “drug substance”—“DS”) encapsulated in a delivery vehicle (“DV”), e.g., a peptoid DV or a lipid nanoparticle (LNP) delivery vehicle (e.g., in the form of “drug product”—“DP”) as described herein. The methods may be used, for example, to de-formulate a delivery vehicle encapsulating a nucleic acid, for example a lipid nanoparticle encapsulating a nucleic acid such as an mRNA or multiple mRNA species, for the purpose of assaying nucleic acid content. Assaying nucleic acid content may include, for example, sequencing the nucleic acid, quantifying the amount of the nucleic acid, determining the size and overall integrity of the nucleic acid, and/or assessing the functional integrity of the nucleic acid. In one aspect, the methods may comprise solubilizing a delivery vehicle with a nonionic surfactant to form an analyte sample comprising a de-formulated DV, introducing the analyte sample into a capillary; and detecting the nucleic acid via capillary electrophoresis (CE). In one aspect, the above steps are performed with no intermediate or additional steps required. For example, once the delivery vehicle is solubilized, it can be directly introduced into a capillary without any “intermediate” step. Upon de-formulation, which entails separating the nucleic acid from the delivery vehicle (such as a lipid nanoparticle), the analyte sample generally comprises the previously encapsulated nucleic acid uncoupled from the delivery vehicle sufficient to allow analysis of the nucleic acid. In certain aspects, the nonionic surfactant may comprise from about 1% to about 10% v/v of the analyte sample.

In an aspect, isolated RNAs, e.g., a first isolated mRNA, second isolated mRNA and/or third isolated mRNA are formulated and/or in communication with a delivery vehicle. In another aspect, at least the first isolated mRNA, second isolated mRNA and/or third isolated mRNA are at least partially encapsulated with the delivery vehicle. In another aspect, at least the first isolated mRNA, second isolated mRNA and/or third isolated mRNA are substantially encapsulated with the delivery vehicle prior to de-formulation. In an aspect, the delivery vehicle is selected from amphipathic molecules, amino-lipidated peptides, and tertiary amino lipidated cationic peptides. In another aspect, the delivery vehicle has a particle size less than or equal to about 200 nm.

In certain aspects, a polyanionic compound, such as a polynucleotide and/or mRNA, and/or other compositions described herein are formulated with a delivery agent or vehicle or delivery vehicle composition to make delivery vehicle complexes or pharmaceutical formulations, also referred to as a drug product (DP) if the polyanionic compound, such as a polynucleotide and/or mRNA, and/or other compositions serves as the drug substance. Such polyanionic compounds may also be referred to as polyanionic cargo compounds or cargos of a delivery vehicle complex (also referred to as a multicomponent delivery system), which complex or system also includes a delivery vehicle composition.

In aspects, the disclosed methods may be used to de-formulate a delivery vehicle or delivery vehicle composition comprising a peptoid, a lipoid, a liposome, a lipoplex, a lipid nanoparticle, a polymeric compound, or a conjugate.

In aspects, the disclosed methods may be used to de-formulate a delivery vehicle or delivery vehicle composition that is a lipid nanoparticles (LNP), such as a cationic lipid nanoparticle. Exemplary cationic lipid nanoparticles are described in, for example, WO2020/219941 and WO2020/097548. In aspects, the disclosed methods may be used to deformulate a delivery vehicle or delivery vehicle composition that includes peptoids, such as tertiary amino lipidated and/or PEGylated cationic peptoids. In aspects, the disclosed methods may be used to de-formulate a delivery vehicle or delivery vehicle composition that is peptoid-based, wherein the delivery vehicle composition comprises, based on the total amount of lipid, more than 50% peptoid, or more than 55% peptoid, or more than 60% peptoid, or more than 65% peptoid, or more than 70% peptoid, or more than 75% peptoid, or more than 80% peptoid, or more than 85% peptoid, or more than 90% peptoid, or more than 95% peptoid. As used herein, “peptoid” refers to a peptidomimetic compound in which one or more of the nitrogen atoms of the peptide backbone are substituted with side chains. As used herein, “lipidated peptoid” refers to a peptoid in which one or more of the side chains on the nitrogen atom comprises a lipid. As used herein, “polyanionic” refers to a compound having at least two negative charges, such as nucleic acids. Exemplary cationic peptoids are described in, for example, WO 2020/069442, WO 2020/069445, WO 2021/030218, and WO 2022/32058, each of which is incorporated herein by reference.

In aspects, the disclosed methods may be used to de-formulate a delivery vehicle or delivery vehicle composition that comprises a cationic peptoid. In aspects, the cationic peptoid is a hydroxyethyl-capped tertiary amino lipidated cationic peptoid. In aspects, the cationic peptoid complexes with polyanionic compounds, such as nucleic acids, including, but not limited to, mRNA (including, but not limited to the first isolated mRNA, the second isolated mRNA or third isolated mRNA described herein), an isolated polynucleotide, a polynucleotide encoding a polypeptide, polynucleotides, and nucleic acids encoding polypeptides, including those described herein.

In aspects, the disclosed methods may be used to de-formulate a delivery vehicle comprising a compound having formula (I)

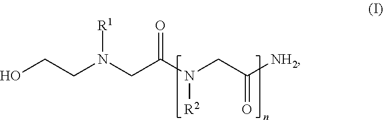

wherein n is 1, 2, 3, 4, 5, or 6; R¹ is H, C₁₋₃alkyl, or hydroxyethyl; and each R² independently is C₈₋₂₄alkyl or C₈₋₂₄alkenyl. In aspects, n is 3. In aspects, n is 4. In aspects, R¹ is H. In aspects, R¹ is ethyl or hydroxyethyl. In cases, R² independently is C₈₋₁₈alkyl or C₈₋₁₈alkenyl. In aspects, each R² is selected from

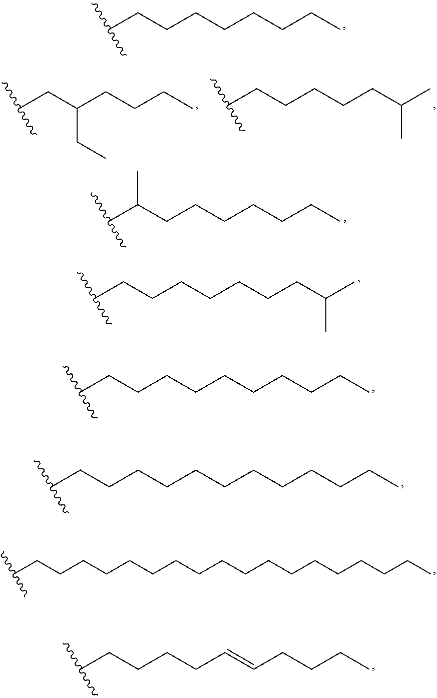

In aspects, each R² independently is selected from

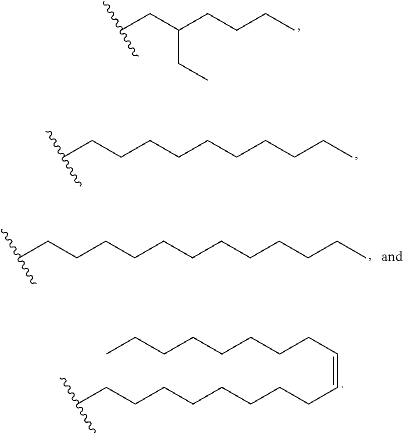

In aspects, R² independently is selected from

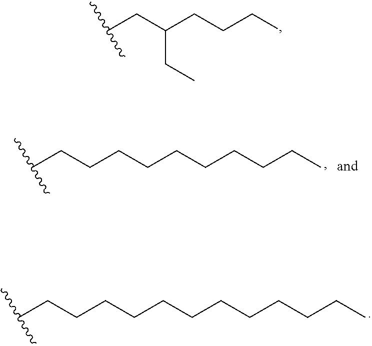

In aspects, each R² is

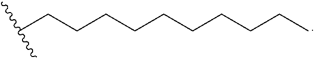 [SMILES: *CCCCCCCCCC]

In aspects, the compound of Formula (I) has a structure selected from:

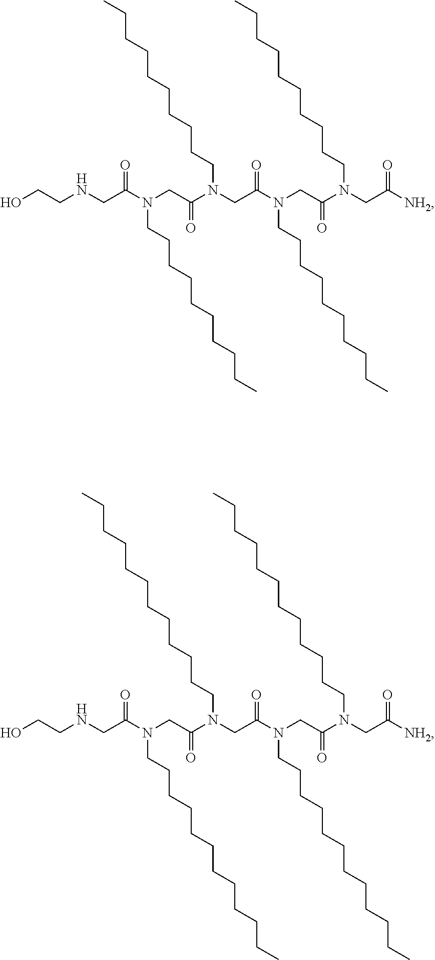 [SMILES: CCCCCCCCCCN(CC(N)=O)C(=O)CN(CCCCCCCCCC)C(=O)CN(CCCCCCCCCC)C(=O)CN(CCCCCCCCCC)C(=O)CNCCO ; CCCCCCCCCCCCN(CC(N)=O)C(=O)CN(CCCCCCCCCCCC)C(=O)CN(CCCCCCCCCCCC)C(=O)CN(CCCCCCCCCCCC)C(=O)CNCCO]

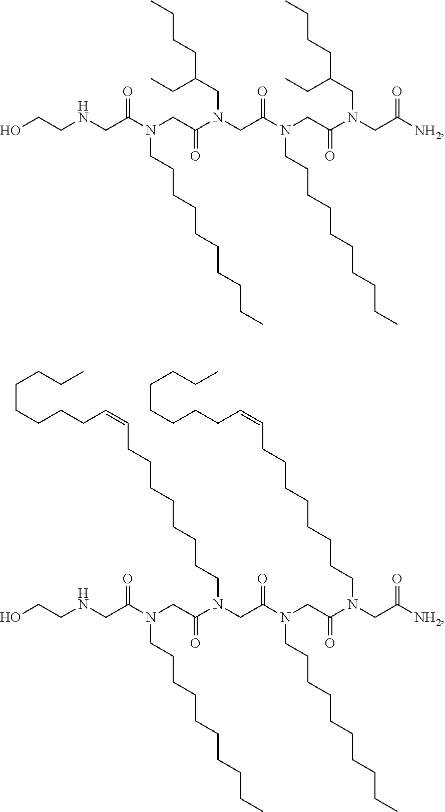 [SMILES: CCCCCCCCCCN(CC(=O)N(CC(=O)N(CCCCCCCCCC)CC(=O)N(CC(N)=O)CC(CC)CCCC)CC(CC)CCCC)C(=O)CNCCO ; CCCCCCCC/C=C\CCCCCCCCN(CC(N)=O)C(=O)CN(CCCCCCCCCC)C(=O)CN(CCCCCCCC/C=C\CCCCCCCC)C(=O)CN(CCCCCCCCCC)C(=O)CNCCO]

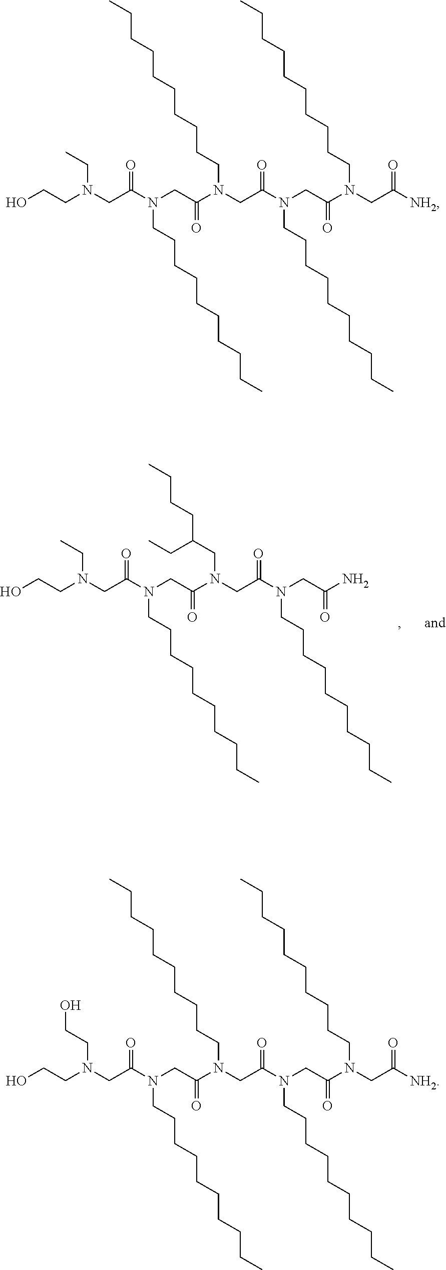 [SMILES: CCCCCCCCCCN(CC(N)=O)C(=O)CN(CCCCCCCCCC)C(=O)CN(CCCCCCCCCC)C(=O)CN(CCCCCCCCCC)C(=O)CN(CC)CCO ; CCCCCCCCCCN(CC(N)=O)C(=O)CN(CC(CC)CCCC)C(=O)CN(CCCCCCCCCC)C(=O)CN(CC)CCO ; CCCCCCCCCCN(CC(N)=O)C(=O)CN(CCCCCCCCCC)C(=O)CN(CCCCCCCCCC)C(=O)CN(CCCCCCCCCC)C(=O)CN(CCO)CCO]

In aspects, the compound of Formula (I) has a structure:

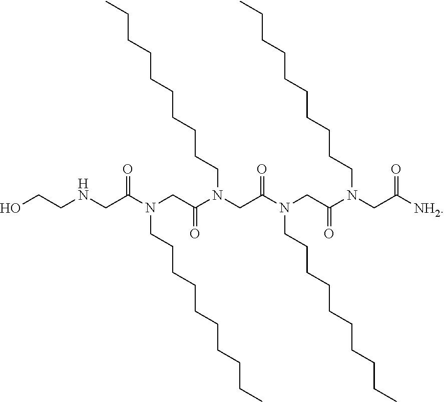 [SMILES: CCCCCCCCCCN(CC(N)=O)C(=O)CN(CCCCCCCCCC)C(=O)CN(CCCCCCCCCC)C(=O)CN(CCCCCCCCCC)C(=O)CNCCO]

Another aspect of the disclosure provides a method of de-formulating an mRNA therapeutic formulation in a delivery vehicle composition including the compounds disclosed above or a pharmaceutically acceptable salt thereof. In aspects, the method may be used to de-formulate a delivery vehicle composition that further includes one or more of a phospholipid, a sterol, and a PEGylated lipid. In aspects, the compound or salt of Formula (I) is present in the delivery vehicle composition in an amount of about 30 mol % to about 60 mol %. In aspects, the compound or salt of Formula (I) is present in the delivery vehicle composition in an amount of about 35 mol % to about 55 mol %. In aspects, the compound or salt of Formula (I) is present in the delivery vehicle composition in an amount of about 30 mol % to about 45 mol %. In aspects, the compound or salt of Formula (I) is present in the delivery vehicle composition in an amount of about 35 mol % to about 39 mol %. In aspects, the compound or salt of Formula (I) is present in the delivery vehicle composition in an amount of about 39 mol % to about 52 mol %. In aspects, the compound or salt of Formula (I) is present in the delivery vehicle composition in an amount of about 30 mol % to about 35 mol %. In aspects, the compound or salt of Formula (I) is present in the delivery vehicle composition in an amount of about 40 mol % to about 45 mol %. In aspects, the compound or salt of Formula (I) is present in an amount of about 42 mol % to about 49 mol %. In aspects, the compound or salt of Formula (I) is present in an amount of about 50 mol % to about 52 mol %.

In aspects, the methods may be used to de-formulate a delivery vehicle composition comprising a phospholipid, a sterol, and a PEGylated lipid. In aspects, the delivery vehicle composition that may be de-formulated using the disclosed methods may include a compound disclosed herein or a salt thereof, a phospholipid, a sterol, and a PEGylated lipid. In aspects, the delivery vehicle composition includes about 30 mol % to about 60 mol % of the compound of Formula (I); about 3 mol % to about 20 mol % of the phospholipid, about 25 mol % to about 60 mol % of the sterol, and about 1 mol % to about 5 mol % of the PEGylated lipid. In aspects, the phospholipid is selected from 1,2-dilinoleoyl-sn-glycero-3-phosphocholine (DLPC), 1,2-dimyristoyl-sn-glycero-phosphocholine (DMPC), 1,2-dioleoyl-sn-glycero-3-phosphocholine (DOPC), 1,2-dipalmitoyl-sn-glycero-3-phosphocholine (DPPC), 1,2-distearoyl-sn-glycero-3-phosphocholine (DSPC), 1,2-diundecanoyl-sn-glycero-phosphocholine (DUPC), 1-palmitoyl-2-oleoyl-sn-glycero-3-phosphocholine (POPC), 1,2-di-O-octadecenyl-sn-glycero-3-phosphocholine (18:0 Diether PC), 1-oleoyl-2-cholesterylhemisuccinoyl-sn-glycero-3-phosphocholine (OChemsPC), 1-hexadecyl-sn-glycero-3-phosphocholine (C 16 Lyso PC), 1,2-dilinolenoyl-sn-glycero-3-phosphocholine, 1,2-diarachidonoyl-sn-glycero-3-phosphocholine, 1,2-didocosahexaenoyl-sn-glycero-3-phosphocholine, 1,2-dioleoyl-sn-glycero-3-phosphoethanolamine (DOPE), 1,2-dipalmitoyl-sn-glycero-3-phosphoethanolamine (DPPE), 1,2-diphytanoyl-sn-glycero-3-phosphoethanolamine (ME 16.0 PE), 1,2-distearoyl-sn-glycero-3-phosphoethanolamine, 1,2-dilinoleoyl-sn-glycero-3-phosphoethanolamine, 1,2-dilinolenoyl-sn-glycero-3-phosphoethanolamine, 1,2-diarachidonoyl-sn-glycero-3-phosphoethanolamine, 1,2-didocosahexaenoyl-sn-glycero-3-phosphoethanolamine, 1,2-dioleoyl-sn-glycero-3-phospho-rac-(1-glycerol) sodium salt (DOPG), sphingomyelin, and combinations thereof. In aspects, the phospholipid is DOPE, DSPC, or a combination thereof. In aspects, the phospholipid is DSPC. In aspects, the sterol is selected from cholesterol, fecosterol, sitosterol, ergosterol, campesterol, stigmasterol, brassicasterol, tomatidine, ursolic acid, alpha-tocopherol, and mixtures thereof. In aspects, the sterol is cholesterol. In aspects, the PEGylated lipid is selected from a PEG-modified phosphatidylethanolamine, a PEG-modified phosphatidic acid, a PEG-modified ceramide, a PEG-modified dialkylamine, a PEG-modified diacylglycerol, a PEG-modified dialkylglycerol, a PEG-modified sterol, and a PEG-modified phospholipid. In implementations, the PEG-modified lipid is selected from PEG-modified cholesterol, N-octanoyl-sphingosine-1-{succinyl[methoxy(polyethylene glycol)]}, N-palmitoyl-sphingosine-1-{succinyl[methoxy(polyethylene glycol)]}, PEG-modified DMPE (DMPE-PEG), PEG-modified DSPE (DSPE-PEG), PEG-modified DPPE (DPPE-PEG), PEG-modified DOPE (DOPE-PEG), dimyristoylglycerol-polyethylene glycol (DMG-PEG), distearoylglycerol-polyethylene glycol (DSG-PEG), dipalmitoylglycerol-polyethylene glycol (DPG-PEG), dioleoylglycerol-polyethylene glycol (DOG-PEG), and a combination thereof. In aspects, the PEG-modified lipid is dimyristoylglycerol-polyethylene glycol 2000 (DMG-PEG 2000).

Further disclosed are methods for de-formulating a therapeutic formulation including one or more polyanionic compounds. In aspects the polyanionic compound is mRNA. In aspects, the polyanionic compound is a first isolated mRNA, a second isolated mRNA or a third isolated mRNA as described herein). In aspects, the polyanionic compound is an isolated polynucleotide. In aspects, the polyanionic compound is polynucleotide encoding a polypeptide described herein. In aspects, the polyanionic compound is part of a delivery vehicle complex including the delivery vehicle composition described herein and a polyanionic compound. In aspects, the compound of Formula (I) or salt thereof is complexed to the polyanionic compound.

In some aspects, the disclosed method may be used to de-formulate a pharmaceutical formulation including one or more mRNA (including, but not limited to, the first isolated mRNA, the second isolated mRNA or third isolated mRNA described herein), an isolated polynucleotide, a polynucleotide encoding a polypeptide, polynucleotides, and nucleic acids encoding polypeptides, including those described herein and a delivery vehicle composition, said delivery vehicle composition comprising Compound 140, DSPC, cholesterol, and DMG-PEG2000, is suspended in a sucrose-containing citrate buffer at a pH between pH 5.0 and pH 6.0, e.g., at pH 5.5.

### BRIEF DESCRIPTION OF THE DRAWINGS

Various aspects of the present disclosure will now be described, by way of example only, with reference to the attached Figures, wherein:

FIG. 1 depict electropherogram traces showing signal when low concentration of Triton X-100 is used during sample preparation following a Sciex procedure and the effect of voltage vs. pressure injection and Triton X-100 concentration on the peak shape and signal quality. Line A shows an electropherogram trace obtained by electrophoresis of the sample mixture with the final TRITON X-100 concentration of 0.07% injected electrokinetically. Line B shows an electropherogram trace obtained by electrophoresis of the sample mixture with the final TRITON X-100 concentration of 5% and injected electrokinetically. Line C shows an electropherogram obtained from the sample prepared exactly as in Line B but injected using pressure injection.

FIG. 2 depicts electropherogram traces generated by electrophoresis of the samples de-formulated using increasing Triton X-100 concentrations. The TRITON X-100 concentrations specified in the Figure are the finial concentrations. The sample were introduced using pressure injection and electrophoresed at 10.0 kV using a 50 cm capillary at 30° C.

FIG. 3 depicts electropherogram traces obtained using a 30 cm (line A) and a 50 cm capillary (line B). The samples were introduced using pressure injection.

FIG. 4. depicts electropherogram traces using separation voltages of 5 kV (Line C), 10 kV (Line B), and 15 kV (Line C), respectively. The sample was introduced into a 50-cm bare fused-silica capillary using a pressure injection (1 psi, 15.0 sec.) and separation was performed at 10.0 kV 30° C. capillary temperature.

FIG. 5 depicts electropherogram traces using capillary temperatures of 35° C. (Line A), 30° C. (Line B), and 25° C. (Line C). The sample was introduced into a 50-cm bare fused-silica capillary using a pressure injection (1 psi, 15.0 sec.) and separation was performed at 10 kV separation voltage and the specified temperature.

FIG. 6 depicts electropherogram traces using various amounts of sample. Increasing volume of the LNP solution containing 1 mg/mL of RNA concentration was treated with the same concentration of TRITON X-100 and electrophoresed using a 50 cm capillary. The samples were prepared with either 10 μL (Line A), 6 μL (Line B) or 4 μL (Line C) of the LNP solution containing 1 mg/mL RNA concentration.

FIG. 7 depicts electropherogram traces illustrating that a 4 μg LNP sample treated with 5% TRITON-X in SLS yields a high-quality electropherogram (Line A) indistinguishable from mRNA co-mixture in the absence of LNP (Line B). Both samples contain SLS. The sample was injected electrokinetically (1.0 kV, 3.0 sec.) into a 30-cm bare fused-silica capillary and electrophoresed at 6 kV and 30° C.

FIG. 8 depicts electropherogram traces illustrating the de-formulation results using commercially available multistep RNA purification methods ((Lithium Chloride precipitation (indicated by “B00949_LiCl”), Monarch Kit (indicated by “B00949_Monarch”), Qiagen Kit (indicated by “B00949_Monarch”)) and the methods of the instant disclosure (indicated by “B00949_De-Formulated”). The samples were introduced into a 50-cm bare fused-silica capillary using a pressure injection (1 psi, 15.0 sec.) and separation was performed at 10 kV separation voltage and 30° C.

FIG. 9 depicts electropherogram traces illustrating the de-formulation results of LNPs containing different delivery vehicles (DV). The established de-formulation procedure was applied to all DVs. The samples were introduced into a 50-cm bare fused-silica capillary using a pressure injection (1 psi, 15.0 sec.) and separation was performed at 10 kV separation voltage and 30° C.

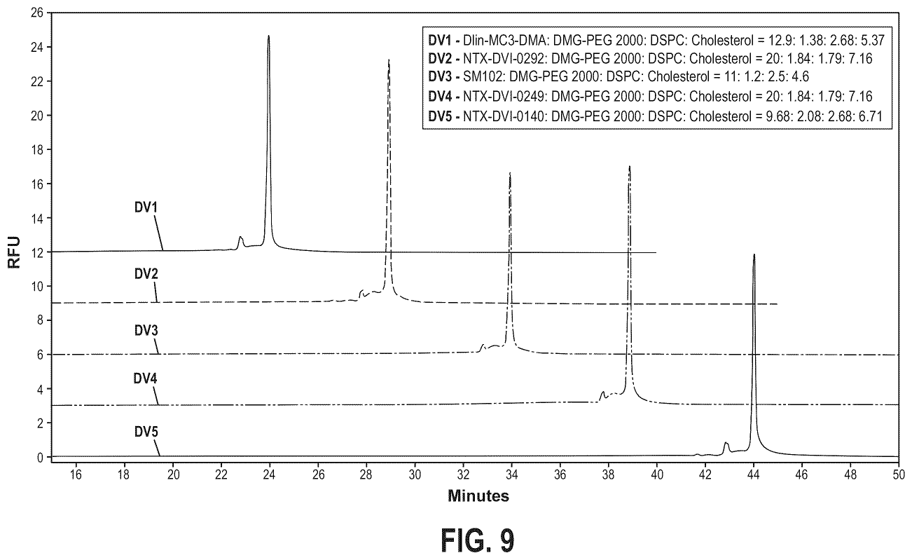

FIG. 10 depicts electropherogram traces illustrating that the de-formulated drug product generates an electropherogram (indicated by “B00949 De-Formulated”) almost identical to that of a drug substance (indicated by “NTX-250 Co-Mixtures”) that has not come in contact with a lipid nanoparticle delivery vehicle.

### DETAILED DESCRIPTION

Unless otherwise defined, all technical and scientific terms used herein have the same meaning as commonly understood by one of ordinary skill in the art to which the methods described herein belong.

The term “about” as used in connection with a numerical value throughout the specification and the claims denotes an interval of accuracy, familiar and acceptable to a person skilled in the art. In general, such interval of accuracy is +/−10%.

Where ranges are given, endpoints are included. Furthermore, unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise.

The term “exemplary” means serving as a non-limiting example, instance, or illustration. As utilized herein, the terms “e.g.,” and “for example” set off lists of one or more non-limiting aspects, examples, instances, or illustrations.

As used herein, the term “substantially” refers to the qualitative condition of exhibiting total or near-total extent or degree of a characteristic or property of interest. Biological and chemical phenomena rarely, if ever, go to completion and/or proceed to completeness or achieve or avoid an absolute result. The term “substantially” is therefore used herein to capture the potential lack of completeness inherent in many biological and chemical phenomena. For example, “substantially” may refer to being within at least about 20%, alternatively at least about 10%, alternatively at least about 5% of a characteristic or property of interest.

The term “nucleic acid,” in its broadest sense, includes any compound and/or substance that comprises a polymer of nucleotides. These polymers are often referred to as polynucleotides. Example nucleic acids or polynucleotides of the disclosure include, but are not limited to, ribonucleic acids (RNAs) or deoxyribonucleic acids (DNAs).

The term “polynucleotide” as used herein refers to polymers of nucleotides of any length, including ribonucleotides, deoxyribonucleotides, analogs thereof, or mixtures thereof. Aspects of this disclosure include compositions including polynucleotides having a length of 18-25 nucleotides (e.g., 18-mers, 19-mers, 20-mers, 21-mers, 22-mers, 23-mers, 24-mers, or 25-mers), or medium-length polynucleotides having a length of 26 or more nucleotides (e.g., polynucleotides of 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, about 65, about 70, about 75, about 80, about 85, about 90, about 95, about 100, about 110, about 120, about 130, about 140, about 150, about 160, about 170, about 180, about 190, about 200, about 210, about 220, about 230, about 240, about 250, about 260, about 270, about 280, about 290, or about 300 nucleotides), or long polynucleotides having a length greater than about 300 nucleotides (e.g., polynucleotides of between about 300 to about 400 nucleotides, between about 400 to about 500 nucleotides, between about 500 to about 600 nucleotides, between about 600 to about 700 nucleotides, between about 700 to about 800 nucleotides, between about 800 to about 900 nucleotides, between about 900 to about 1000 nucleotides, between about 300 to about 500 nucleotides, between about 300 to about 600 nucleotides, between about 300 to about 700 nucleotides, between about 300 to about 800 nucleotides, between about 300 to about 900 nucleotides, or about 1000 nucleotides in length, or even greater than about 1000 nucleotides in length.

Where a polynucleotide is double-stranded, its length may be similarly described in terms of base pairs. This term refers to the primary structure of the molecule. Thus, the term includes triple-, double- and single-stranded deoxyribonucleic acid (“DNA”), as well as triple-, double- and single-stranded ribonucleic acid (“RNA”). More particularly, the term “polynucleotide” includes polydeoxyribonucleotides (containing 2-deoxy-D-ribose), polyribonucleotides (containing D-ribose), including tRNA, rRNA, hRNA, siRNA, and mRNA, whether spliced or unspliced, any other type of polynucleotide which is an N- or C-glycoside of a purine or pyrimidine base, and other polymers containing normucleotidic backbones, for example, polyamide (e.g., peptide nucleic acids “PNAs”) and polymorpholino polymers, and other synthetic sequence-specific nucleic acid polymers providing that the polymers contain nucleobases in a configuration which allows for base pairing and base stacking, such as is found in DNA and RNA. In particular aspects, the polynucleotide comprises an mRNA.

As used herein, the term “messenger RNA” (mRNA) refers to any polynucleotide that encodes a polypeptide of interest and is capable of being translated to produce the encoded polypeptide in vitro, in vivo, in situ, or ex vivo.

In addition to messenger RNA, several non-coding types of RNA exist which may be involved in regulation of transcription and/or translation, and immunostimulation. Within the present disclosure the term “RNA” further encompasses any type of single stranded (ssRNA) or double stranded RNA (dsRNA) molecule known in the art, such as viral RNA, retroviral RNA and replicon RNA, small interfering RNA (siRNA), antisense RNA (asRNA), circular RNA (circRNA), ribozymes, aptamers, riboswitches, immunostimulating/immunostimulatory RNA, transfer RNA (tRNA), ribosomal RNA (rRNA), small nuclear RNA (snRNA), small nucleolar RNA (snoRNA), microRNA (miRNA), and Piwi-interacting RNA (piRNA).

As used herein, “delivery vehicle” refers to any substance that facilitates, at least in part, the in vivo, in vitro, or ex vivo delivery of a polynucleotide (e.g., therapeutic polynucleotide) to targeted cells or tissues (e.g., tumors, etc.). Referring to something as a delivery vehicle need not exclude the possibility of the delivery vehicle also having therapeutic effects. Some versions of a delivery vehicle may provide additional therapeutic effects. In some versions, a delivery vehicle may be a peptoid molecule, such as an amino-lipidated peptoid molecule, that may be used to at least partially encapsulate mRNA. The term “DV” may also be used herein as a shorthand for “delivery vehicle.” In some aspects, the mRNA for use in the delivery vehicle complexes herein comprise an mRNA comprising at least one region encoding a peptide (e.g., a polypeptide), protein, or functional fragment of the foregoing. As used herein, “functional fragment” refers to a fragment of a peptide, (e.g., a polypeptide), or protein that retains the ability to induce an immune response.

The delivery vehicle compositions disclosed herein can form complexes with one or more polyanionic compounds (e.g., nucleic acids) through an electrostatic interaction between the cationic component of the delivery vehicle composition and the polyanionic compound. Thus, in aspects, the delivery vehicle complex (or drug product, “DP” if the polyanionic compound is a drug substance) refers to a mixture comprising a delivery vehicle composition and a polyanionic compound. The complexes, in some instances, permit a high amount of cargo encapsulation, are stable, and demonstrate excellent efficiency and tolerability in vivo. The delivery vehicle complexes, therefore, are useful as delivery vehicles for the transportation of the polyanionic cargo encapsulated therein to a target cell. Additionally or alternatively, the delivery vehicle complexes can include a non-anionic cargo.

As used herein, “multimodal” refers to a therapeutic composition that includes at least two different therapeutic polynucleotides, alternatively at least three different therapeutic polynucleotides.

As used herein, the term “isolated” refers to a substance or entity that has been separated from at least some of the components with which it was associated (whether in nature or in an experimental setting). Isolated substances (e.g., nucleotide sequence or protein sequence) can have varying levels of purity in reference to the substances from which they have been associated.

A polynucleotide, vector, polypeptide, cell, or any composition disclosed herein which is “isolated” is a polynucleotide, vector, polypeptide, cell, or composition which is in a form not found in nature. Isolated polynucleotides, vectors, polypeptides, or compositions include those that have been purified to the degree that they are no longer in a form in which they are found in nature. In some aspects, a polynucleotide, vector, polypeptide, or composition that is isolated is substantially pure.

The terms “polypeptide,” “peptide,” and “protein” are used interchangeably herein to refer to polymers of amino acids of any length. The polymer can comprise modified amino acids. The terms also encompass an amino acid polymer that has been modified naturally or by intervention; for example, disulfide bond formation, glycosylation, lipidation, acetylation, phosphorylation, or any other manipulation or modification, such as conjugation with a labeling component. Methods of making polynucleotides of a predetermined sequence are well-known. Solid-phase synthesis methods are known for both polyribonucleotides and polydeoxyribonucleotides (the well-known methods of synthesizing DNA are also useful for synthesizing RNA). Polyribonucleotides can also be prepared enzymatically. Non-naturally occurring nucleobases can be incorporated into the polynucleotide, as well. In aspects, a peptide comprises from about 2 to about 50 amino acids. In aspects, a protein comprise more than 50 amino acids.

Disclosed herein are methods for analyzing a nucleic acid encapsulated in a delivery vehicle (DV), e.g., a lipid nanoparticle (LNP). The methods may be used, for example, to de-formulate a delivery vehicle encapsulating a nucleic acid. In aspects, the methods may be used to de-formulate a delivery vehicle encapsulating at least two different nucleic acids, or at least three different nucleic acids, or at least four different nucleic acids, or five or more nucleic acids. In aspects, the method may be used to de-formulate a lipid nanoparticle encapsulating an mRNA or multiple (more than one) mRNA species, for the purpose of assaying nucleic acid content and/or determining the purity or the composition and/or the presence of contaminants. Assaying nucleic acid content may include, for example, sequencing the nucleic acid, quantifying the amount of the nucleic acid, determining the overall integrity of the nucleic acid, and/or assessing the functional integrity of the nucleic acid. In one aspect, the method may comprise solubilizing a DV, e.g., a peptoid-based DV or an LNP, with a nonionic surfactant to form an analyte sample comprising a de-formulated DV, the de-formulated DV generally comprising the previously encapsulated nucleic acid separated from the delivery vehicle sufficient to allow analysis of the nucleic acid, for example via capillary electrophoresis (CE), the nonionic surfactant comprising from about 1% to about 10% v/v of the analyte sample; introducing the analyte sample into a capillary; and detecting the nucleic acid via capillary electrophoresis (CE). In aspects, the de-formulation method is a one-step method, in which the drug product (delivery vehicle+nucleic acid) is de-formulated, followed by analysis of the nucleic acid by CE. In aspects, the de-formulation method is a one-step method, in which the drug product (delivery vehicle+nucleic acid) is de-formulated, followed by analysis of the nucleic acid by CE, without an intermediate cleaning step which separates the nucleic acid from the delivery vehicle. In one aspect, the detecting may be performed using light induced fluorescence with SYBR™ Green II RNA Gel Stain (laser-induced fluorescence detection). In aspects, the detecting may be performed using a Quanti-iTTMRiboGreen™ reagent (catalog numbers R11490, R11481, and T11493, available from Invitrogen®). The Quanti-iTTMRiboGreen™ RNA reagent is a fluorescent nucleic acid stain for quantifying RNA in solution. In aspects, the detecting may be performed using the P800+. In aspects, the detecting comprises one or both of determining nucleic acid purity (the presence or absence of nucleic acid fragments) and nucleic acid integrity (specific size of nucleic acid).

In one aspect, the nucleic acid may be a nucleic acid as described herein, for example, a single stranded RNA (ssRNA), a double stranded RNA (dsRNA), a viral RNA, a retroviral RNA replicon RNA, a small interfering RNA (siRNA), an antisense RNA (asRNA), a circular RNA (circRNA), a ribozyme, an aptamer, a riboswitche, an immunostimulating/immunostimulatory RNA, a transfer RNA (tRNA), a ribosomal RNA (rRNA), a small nuclear RNA (snRNA), a small nucleolar RNA (snoRNA), a microRNA (miRNA), a Piwi-interacting RNA (piRNA), and combinations thereof, formulated with a delivery vehicle, the delivery vehicle at least partially encapsulating, or substantially encapsulating the nucleic acid. In one aspect, the nucleic acid encapsulated in the DV may comprises at least one, or at least two, or at least three, or at least four, or at least five nucleic acid species, or, in certain aspects, more than five nucleic acid species. In one aspect, the nucleic acid may have a size of from about 1000 to about 10,000 kb, or from about 2000 kb to about 8000 kb, or from about 4000 kb to about 6000 kb. In one aspect, the nucleic acid may be present in the analyte sample in an amount of from about 1 to about 25 μg, or from about 2 to about 20 μg, or from about 3 to about 15 μg, or from about 4 to about 10 μg or from about 5 to about 12 μg.

In one aspect, the nonionic surfactant may be present in the analyte sample at a concentration of from about 2% to about 8%, or from about 4% to about 6% of the analyte sample. Exemplary nonionic surfactants include, for example, polyoxyethylene surfactants, carboxylic ester surfactants, carboxylic amide surfactants, etc. Commercially available nonionic surfactants include, n-dodecanoylsucrose, n-dodecyl-β-D-glucopyranoside, n-octyl-β-D-maltopyranoside, n-octyl-β-D-thioglucopyranoside, n-decanoylsucrose, n-decyl-β-D-maltopyranoside, n-decyl-β-D-thiomaltoside, n-heptyl-β-D-glucopyranoside, n-heptyl-β-D-thioglucopyranoside, n-hexyl-β-D-glucopyranoside, n-nonyl-β-D-glucopyranoside, n-octanoylsucrose, n-octyl-β-D-glucopyranoside, cyclohexyl-n-hexyl-β-D-maltoside, cyclohexyl-n-methyl-β-D-maltoside, digitonin, and those available under the trade designations PLURONIC, TRITON, TWEEN, for example, Triton X-100, available from Dow Chemical. See, for example, US2005068628. In one aspect, the nonionic surfactant may be Triton X-100.

The methods may be used to deformulate a delivery vehicle encapsulating a nucleic acid. For example, in one aspect, the DV may comprise a hydroxyethyl-capped tertiary amino lipidated cationic peptoid. In one aspect, the DV may comprise an anionic/zwitterionic component. In one aspect, the DV may comprise a PEGylated lipid. In one aspect, the DV may comprise a neutral lipid component. In one aspect, the DV may comprise a sterol. In one aspect, the DV may comprise a shielding component. In one aspect, the DV may be F6.3 as described herein.

In one aspect, the analyte sample comprises a drug product, the drug product comprising a delivery vehicle, as described herein, partially or substantially encapsulating a nucleic acid. In one aspect, the analyte sample may comprise a de-formulated drug product. The analytes sample comprising a de-formulated drug product may be subjected to capillary electrophoresis (CE) for resolution of the component parts, most particularly the nucleic acids of the drug product. CE is an analytical technique used for separating and analyzing ions, small molecules, and biomolecules based on their charge-to-size ratio. In CE, analytes are separated as they migrate through a narrow capillary under the influence of an electric field. The method may generally comprise solubilizing a drug product (such as a DV comprising a nucleic acid) to form an analyte sample, followed by introducing the analyte sample into a capillary of a device designed to perform capillary electrophoresis, followed by detection of the nucleic acid via CE.

Heating or cooling can affect several variables, including fluorescence intensity (FI) measured in a CE assay, denaturation of a nucleic acid, and viscosity of the analyte sample. In aspects, the method may comprise heating the analyte sampleto a temperature of about 70° C. prior to detecting the nucleic acid via CE. In aspects, the analyte sample may be heated prior to contacting the analyte sample with the capillary. In aspects, the analyte sample may be heated while within the capillary. In aspects, the analyte sample may be cooled prior to the detecting the nucleic acid via CE.

Various methods of carrying out CE may be used. In one aspect, the analyte sample may be introduced into a capillary of a device designed to perform CE via pressure injection. In pressure injection, the sample is introduced into the capillary by applying a controlled pressure or vacuum, which allows for precise control over the injection volume. In one aspect, the analyte sample may be introduced into the capillary of a device designed to perform CE via electrokinetic injection. Electrokinetic injection relies on the application of an electric field to introduce the sample into the capillary. Following introduction of the analyte sample into a capillary of a device designed to perform capillary electrophoresis, a voltage is applied to separate and resolve the components of the analyte sample. In one aspect, the analyte sample, once introduced into the capillary, may be subjected to a separation voltage of from about 5 to about 15 kV, or about 10 kV.

The length of the capillary in CE may directly influence the resolution, efficiency, and analysis time of the separation process. Longer capillaries generally provide higher resolution and efficiency but may require longer analysis times and optimization of instrumental parameters. In one aspect, the CE capillary used may have a length of about 50 cm.

In aspects, the analyte sample may be subjected to a separation voltage of from about 2 to about 15 kV, or about 6 kV wherein the capillary has a length of about 30 cm. In aspects, the capillary may have a temperature of from about 25° C. to about 35° C., or about 30° C. In aspects, the capillary may have a length of from about 30 cm to about 80 cm, or about 50 cm. In aspects, the data resulting from the disclosed methods may be collected at a rate of about 8 Hz (data point per second).

The methods may be used to de-formulate delivery vehicles comprising a nucleic acid, more particularly an mRNA, as described herein. Any method known in the art for making RNA, including, but not limited to making mRNA, is contemplated herein. Illustrative methods for making RNA include but are not limited to, chemical synthesis and in vitro transcription.

In certain aspects, the RNA for use in the methods herein is chemically synthesized. Chemical synthesis of relatively short fragments of oligonucleotides with defined chemical structure provides rapid and inexpensive access to custom-made oligonucleotides of any desired sequence. Whereas enzymes synthesize DNA, RNA, and mRNA only in the 5′ to 3′ direction, chemical oligonucleotide synthesis does not have this limitation, although it is most often carried out in the opposite, i.e. the 3′ to 5′ direction. In certain implementations, the process is implemented as solid-phase synthesis using the phosphoramidite method and phosphoramidite building blocks derived from protected nucleosides (A, C, G, and U), or chemically modified nucleosides.

In some aspects, modifications are included in the modified nucleic acid or in one or more individual nucleoside or nucleotide. For example, modifications to a nucleoside may include one or more modifications to the nucleobase, the sugar, and/or the internucleoside linkage. In some implementations having at least one modification, the polynucleotide includes a backbone moiety containing the nucleobase, sugar, and internucleoside linkage of: pseudouridine-alpha-thio-MP, 1-methyl-pseudouridine-alpha-thio-MP, 1-ethyl-pseudouridine-MP, 1-propyl-pseudouridine-MP, 1-(2,2,2-trifluoroethyl)-pseudouridine-MP, 2-amino-adenine-MP, xanthosine-MP, 5-bromo-cytidine-MP, 5-aminoallyl-cytidine-MP, or 2-aminopurine-riboside-MP.

In aspects, the modified nucleic acid comprises at least one modification. In aspects, the nucleic acid comprises a polynucleotide comprising a backbone moiety containing the nucleobase, sugar, and internucleoside linkage of: pseudouridine-alpha-thio-MP, 1-methyl-pseudouridine-alpha-thio-MP, or 5-bromo-cytidine-MP. Nucleoside and nucleotide modifications contemplated for use in the present disclosure are known in the art.

To obtain the desired oligonucleotide, the building blocks are sequentially coupled to the growing oligonucleotide chain on a solid phase in the order required by the sequence of the product in a fully automated process. Upon the completion of the chain assembly, the product is released from the solid phase to the solution, deprotected, and collected. The occurrence of side reactions sets practical limits for the length of synthetic oligonucleotides (up to about 200 nucleotide residues), because the number of errors increases with the length of the oligonucleotide being synthesized. Products are often isolated by HPLC to obtain the desired oligonucleotides in high purity.

In certain aspects, the encapsulated RNA is made using in vitro transcription. The terms “RNA in vitro transcription” or “in vitro transcription” relate to a process wherein RNA is synthesized in a cell-free system (in vitro). DNA, particularly plasmid DNA, is used as a template for the generation of RNA and/or mRNA transcripts. RNA may be obtained by DNA-dependent in vitro transcription of an appropriate DNA template, which in certain implementations is a linearized plasmid DNA template. The promoter for controlling in vitro transcription can be any promoter for any DNA-dependent mRNA polymerase. Examples of DNA-dependent RNA polymerases are the T7, T3, and SP6 RNA polymerases. A DNA template for in vitro RNA transcription may be obtained by cloning of a nucleic acid, in particular cDNA corresponding to the respective RNA to be in vitro transcribed, and introducing it into an appropriate vector for in vitro transcription, for example into plasmid DNA. In one aspect of the present disclosure, the DNA template is linearized with a suitable restriction enzyme, before it is transcribed in vitro. The cDNA may be obtained by reverse transcription of mRNA or chemical synthesis. Moreover, the DNA template for in vitro RNA synthesis may also be obtained by gene synthesis.

Methods for in vitro transcription are known in the art. Reagents used in the methods typically include: 1) a linearized DNA template with a promoter sequence that has a high binding affinity for its respective RNA polymerase such as bacteriophage-encoded RNA polymerases; 2) ribonucleoside triphosphates (NTPs) for the four bases (adenine, cytosine, guanine and uracil); 3) in aspects, a cap analogue as defined above (e.g. m7G(5′)ppp(5′)G (m7G)); 4) a DNA-dependent RNA polymerase capable of binding to the promoter sequence within the linearized DNA template (e.g. T7, T3 or SP6 RNA polymerase); 5) optionally a ribonuclease (RNase) inhibitor to inactivate any contaminating RNase; 6) optionally a pyrophosphatase to degrade pyrophosphate, which may inhibit transcription; 7) MgCl2, which supplies Mg2+ ions as a co-factor for the polymerase; 8) a buffer to maintain a suitable pH value, which can also contain antioxidants (e.g. DTT), and/or polyamines such as spermidine at optimal concentrations.

In aspects, the methods may be used to de-formulate an mRNA-based therapeutic composition that is formulated with and/or in communication with a delivery vehicle. A “delivery vehicle” refers to any substance that facilitates, at least in part, the in vivo, in vitro, or ex vivo delivery of a polynucleotide to targeted cells or tissues (e.g., tumors, etc.). Referring to something as a delivery vehicle does not mean that it may not also have therapeutic effects. Delivery vehicles include, but are not limited to, viral vectors and particles such as lentivirus, adenovirus, adeno-associated virus, herpes simplex virus, retrovirus, and the like. Other modalities may also be used such as mRNA, plasmids, and recombinant proteins. As used herein, “drug product” or “DP” is composed of a therapeutic drug substance (“DS”), an mRNA, encapsulated in a lipid-based delivery vehicle. In general, the DP comprises a delivery vehicle that partially or substantially encompasses a nucleic acid. In aspects, a DP comprises a delivery vehicle that partially or substantially encompasses a DNA. In aspects, a DP comprises a delivery vehicle that partially or substantially encompasses an RNA. In aspects, a DP comprises a delivery vehicle that partially or substantially encompasses an mRNA.

The delivery vehicle compositions that may be used with the disclosed methods may comprise hydroxyethyl-capped cationic peptoids, including, for example, hydroxyethyl-capped tertiary amino lipidated cationic peptoids. The delivery vehicle compositions may form an electrostatic interaction between the hydroxyethyl-capped tertiary amino lipidated cationic peptoids of the delivery vehicle composition and a polyanionic compound, such as a nucleic acid, to form a delivery vehicle complex, wherein the polyanionic compound functions as the cargo of the complex. The disclosed methods may be used to de-formulate delivery vehicle complexes comprising (encapsulating) polyanionic compounds, such as nucleic acids (e.g., mRNA), into cells. The delivery vehicle complexes may comprise mRNA as the polyanionic cargo. In aspects, the mRNA of the delivery vehicle may encode, e.g., a viral antigen and may be a vaccine composition

As used herein, “peptoid” refers to a peptidomimetic compound in which one or more of the nitrogen atoms of the peptide backbone are substituted with side chains. As used herein, “lipidated peptoid” refers to a peptoid in which one or more of the side chains on the nitrogen atom comprises a lipid. As used herein, “polyanionic” refers to a compound having at least two negative charges, such as nucleic acids.

In aspects, the methods may be used to de-formulate delivery vehicle compositions comprising one or more hydroxyethyl-capped tertiary amino lipidated cationic peptoids. These positively charged peptoids can associate with a polyanionic compound, such as a nucleic acid, to form a delivery vehicle complex. In aspects, the methods may be used to deformulate delivery vehicle compositions that further comprise one or more of an anionic or zwitterionic component, such as a phospholipid; a neutral lipid, such as a sterol; and a shielding lipid, such as a PEGylated lipid. In aspects, methdos may be used to de-formulate delivery vehicle compositions that further comprise an anionic or zwitterionic component (e.g., a phospholipid), a neutral lipid (e.g., a sterol), and a shielding lipid (e.g., a PEGylated lipid). In aspects, the methods may be used to deformulate delivery vehicle compositions that consist essentially of a hydroxyethyl-capped tertiary amino lipidated cationic peptoid, an anionic or zwitterionic component (e.g., a phospholipid), a neutral lipid (e.g., a sterol), and a shielding lipid (e.g., a PEGylated lipid).

### Hydroxyethyl-Capped Tertiary Amino Lipidated Cationic Peptoid Component

Exemplary delivery vehicle compositions suitable for use with the current invention are described in WO2023/014931, incorporated herein by reference. Exemplary hydroxyethyl-capped tertiary amino lipidated cationic peptoids useful in connection with delivery vehicle compositions that may be de-formulated using the disclosed methods are listed in Table 1.

TABLE 1
Examples of hydroxyethyl-capped tertiary amino lipidated cationic peptoids.

| Compound | Structure |
|---|---|
| 140 | 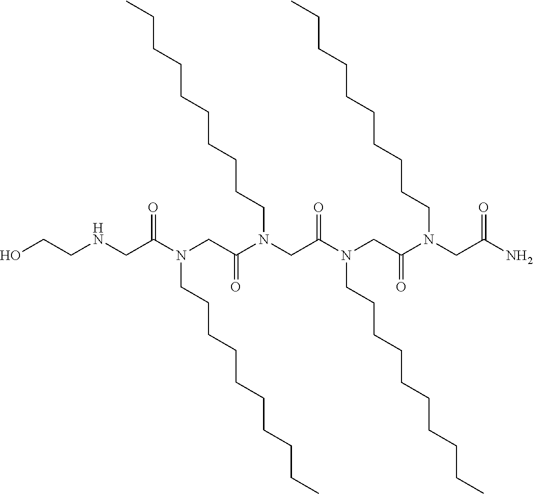 [SMILES: CCCCCCCCCCN(CC(N)=O)C(=O)CN(CCCCCCCCCC)C(=O)CN(CCCCCCCCCC)C(=O)CN(CCCCCCCCCC)C(=O)CNCCO] |
| 146 | 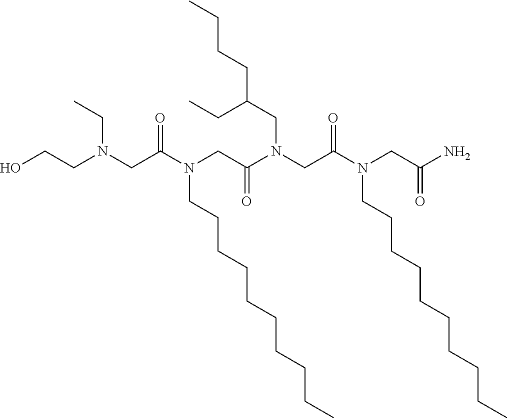 [SMILES: CCCCCCCCCCN(CC(N)=O)C(=O)CN(CC(CC)CCCC)C(=O)CN(CCCCCCCCCC)C(=O)CN(CC)CCO] |
| 151 | 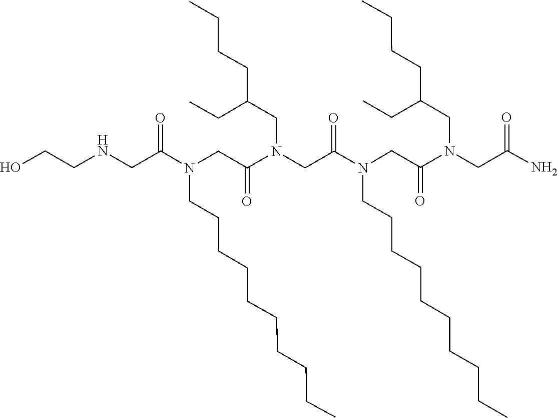 [SMILES: CCCCCCCCCCN(CC(=O)N(CC(=O)N(CCCCCCCCCC)CC(=O)N(CC(N)=O)CC(CC)CCCC)CC(CC)CCCC)C(=O)CNCCO] |
| 152 | 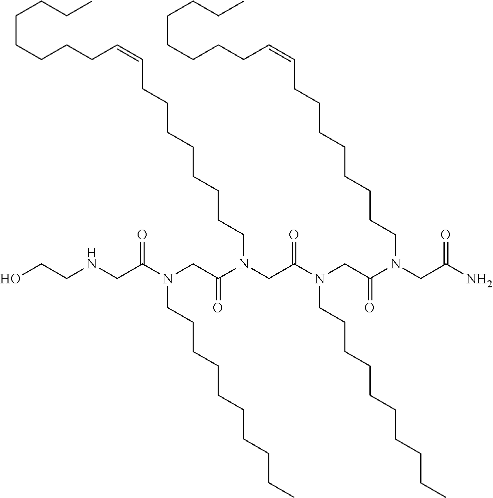 [SMILES: CCCCCCCC/C=C\CCCCCCCCN(CC(N)=O)C(=O)CN(CCCCCCCCCC)C(=O)CN(CCCCCCCC/C=C\CCCCCCCC)C(=O)CN(CCCCCCCCCC)C(=O)CNCCO] |
| 160 | 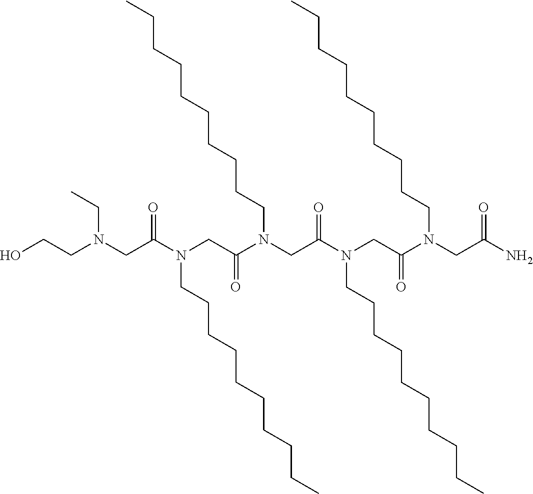 [SMILES: CCCCCCCCCCN(CC(N)=O)C(=O)CN(CCCCCCCCCC)C(=O)CN(CCCCCCCCCC)C(=O)CN(CCCCCCCCCC)C(=O)CN(CC)CCO] |
| 161 | 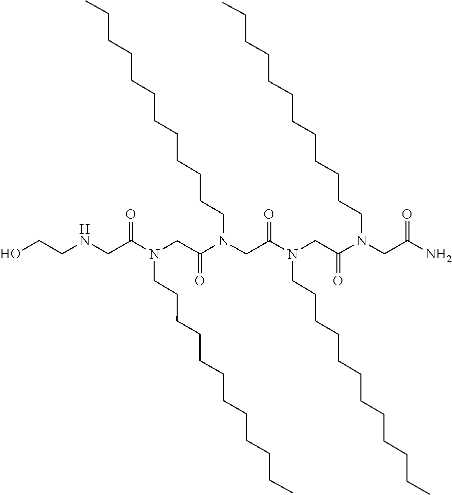 [SMILES: CCCCCCCCCCCCN(CC(N)=O)C(=O)CN(CCCCCCCCCCCC)C(=O)CN(CCCCCCCCCCCC)C(=O)CN(CCCCCCCCCCCC)C(=O)CNCCO] |
| 162 | 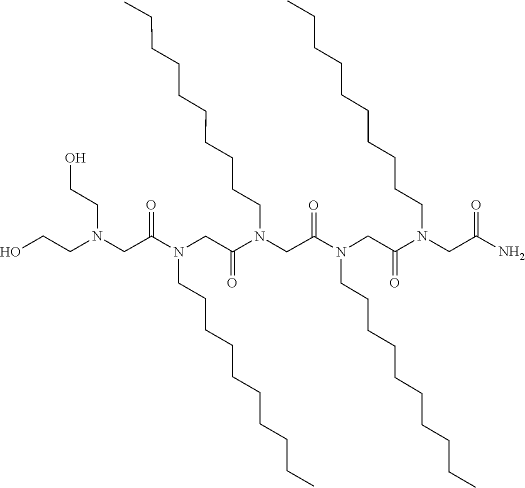 [SMILES: CCCCCCCCCCN(CC(N)=O)C(=O)CN(CCCCCCCCCC)C(=O)CN(CCCCCCCCCC)C(=O)CN(CCCCCCCCCC)C(=O)CN(CCO)CCO] |

In aspects, the methods may be used to de-formulate a delivery vehicle composition comprising between about 25 mol % to about 70 mol % of the hydroxyethyl-capped tertiary amino lipidated cationic peptoid (e.g., a compound of Formula (I), such as Compound 140), based on the total number of moles of components in the delivery vehicle composition. The unit “mol %” or “molar percentage” refers to the number of moles of a particular component of the delivery vehicle composition divided by the total number of moles of all components in the delivery vehicle composition, times 100%. The polyanionic cargo is not calculated as part of the total number of moles of the delivery vehicle composition. In some aspects, the methods may be used to de-formulate a delivery vehicle composition comprising between about 30 mol % to about 60 mol %, or about 35 mol % to about 55 mol %, or about 30 mol % to about 45 mol %, or about 35 mol % to about 40 mol %, or about 45 mol % to about 60 mol %, or about 50 mol % to about 55 mol %, or about 38 mol % to about 52 mol %, or about 38 mol %, or about 52 mol % of the hydroxyethyl-capped tertiary amino lipidated cationic peptoid (e.g., a compound of Formula (I), such as Compound 140), based on the total number of moles of components in the delivery vehicle composition.

### Anionic/Zwitterionic Component

In some aspects, the methods may be used to de-formulate a delivery vehicle composition that further includes a component that is anionic or zwitterionic (“anionic/zwitterionic component”). The anionic/zwitterionic component can buffer the zeta potential of a particle or a delivery vehicle complex formed from the delivery vehicle composition, without affecting the ratio of the cargo and/or contributing to particle or delivery vehicle endosomal escape through protonation at low pH in the endosome. Zwitterionic components can serve a further function of holding particles together by interacting with both the hydroxyethyl-capped tertiary amino lipidated cationic peptoid and the polyanionic cargo compounds. Anionic components can also allow for the formation of a core-shell structure of the particle or delivery vehicle, where first a net positive zeta potential particle is made (e.g., by mixing the hydroxyethyl-capped tertiary amino lipidated cationic peptoid and the cargo at a positive+/−charge ratio), which is then coated with the anionic components. These negatively charged multicomponent system particles would avoid reticuloendothelial system (RES) clearance better than positively charged ones.

Example of suitable anionic and zwitterionic components of the delivery vehicle composition are described in WO2020/069442 and WO2020/069445, each of which is incorporated herein by reference in its entirety. In aspects, the zwitterionic component comprises one or more phospholipids. Phospholipids can provide further stabilization to complexes in solution, as well as facilitate cell endocytosis, by virtue of their amphipathic character and ability to disrupt the cell membrane.

In aspects, the one or more phospholipids of the delivery vehicle are selected from 1,2-dilinoleoyl-sn-glycero-3-phosphocholine (DLPC), 1,2-dimyristoyl-sn-glycero-phosphocholine (DMPC), 1,2-dioleoyl-sn-glycero-3-phosphocholine (DOPC), 1,2-dipalmitoyl-sn-glycero-3-phosphocholine (DPPC), 1,2-distearoyl-sn-glycero-3-phosphocholine (DSPC), 1,2-diundecanoyl-sn-glycero-phosphocholine (DUPC), 1-palmitoyl-2-oleoyl-sn-glycero-3-phosphocholine (POPC), 1,2-di-O-octadecenyl-sn-glycero-3-phosphocholine (18:0 Diether PC), 1-oleoyl-2-cholesterylhemisuccinoyl-sn-glycero-3-phosphocholine (OChemsPC), 1-hexadecyl-sn-glycero-3-phosphocholine (C 16 Lyso PC), 1,2-dilinolenoyl-sn-glycero-3-phosphocholine, 1,2-diarachidonoyl-sn-glycero-3-phosphocholine, 1,2-didocosahexaenoyl-sn-glycero-3-phosphocholine, 1,2-dioleoyl-sn-glycero-3-phosphoethanolamine (DOPE), 1,2-dipalmitoyl-sn-glycero-3-phosphoethanolamine (DPPE), 1,2-diphytanoyl-sn-glycero-3-phosphoethanolamine (ME 16.0 PE), 1,2-distearoyl-sn-glycero-3-phosphoethanolamine, 1,2-dilinoleoyl-sn-glycero-3-phosphoethanolamine, 1,2-dilinolenoyl-sn-glycero-3-phosphoethanolamine, 1,2-diarachidonoyl-sn-glycero-3-phosphoethanolamine, 1,2-didocosahexaenoyl-sn-glycero-3-phosphoethanolamine, 1,2-dioleoyl-sn-glycero-3-phospho-rac-(1-glycerol) sodium salt (DOPG), sphingomyelin, and mixtures thereof. In aspects, the phospholipid is DSPC, DOPE, or a combination thereof. In aspects, the phospholipid is DSPC. In aspects, the phospholipid is DOPE.

### Neutral Lipid Component

In aspects, the methods may be used to de-formulate a delivery vehicle composition that further includes a component that is a neutral lipid (“neutral lipid component”). The neutral lipid component can be designed to degrade or hydrolyze to facilitate in vivo clearance of the multicomponent delivery system. Contemplated neutral lipid components include, for example, naturally-occurring lipids and lipidated peptoids comprising lipid moieties at the N-position of the peptoid. Further examples of lipidated petoids are described in WO2020/069442 and WO2020/069445, each of which is incorporated herein by reference in its entirety.

In aspects, the neutral lipid component of the delivery vehicle composition comprises one or more sterols. In aspects, the one more sterols are selected from cholesterol, fecosterol, sitosterol, ergosterol, campesterol, stigmasterol, brassicasterol, tomatidine, ursolic acid, alpha-tocopherol, and mixtures thereof. In aspects, the sterol comprises cholesterol. In aspects, the delivery vehicle composition comprises between about 10 mol % to about 80 mol % of the sterol (e.g., cholesterol), based on the total number of moles of components in the delivery vehicle composition. Shielding Component

In aspects, the methods may be used to de-formulate a delivery vehicle composition that further comprises a shielding component. The shielding component can increase the stability of the particle or delivery vehicle in vivo by serving as a steric barrier, thus improving circulation half-life. Examples of suitable shielding components are described in WO2020/069442 and WO2020/069445, each of which is incorporated herein by reference in its entirety.

In aspects, the shielding component comprises one or more PEGylated lipids. As used herein, a “PEGylated lipid” includes any lipid or lipid-like compound covalently bound to a polyethylene glycol moiety. Suitable lipid moieties for the PEGylated lipid can include, for example, branched or straight chain aliphatic moieties that can be unsubstituted or substituted, or moieties derived from natural lipid compounds, including fatty acids, sterols, and isoprenoids, that either be unsubstituted or substituted.

In aspects, the lipid moieties may include branched or straight chain aliphatic moieties having from about 6 to about 50 carbon atoms or from about 10 to about 50 carbon atoms. The aliphatic moieties can comprise, in aspects, one or more heteroatoms, and/or one or more double or triple bonds (i.e., saturated or mono- or poly-unsaturated). In aspects, the lipid moieties may include aliphatic, straight chain or branched moieties, each hydrophobic tail independently having from about 8 to about 30 carbon atoms or from about 6 to about 30 carbon atoms, wherein the aliphatic moieties can be unsubstituted or substituted. In aspects, the lipid moieties may include, for example, aliphatic carbon chains derived from fatty acids and fatty alcohols. In aspects, each lipid moiety is independently C₈-C₂₄-alkyl or C₈-C₂₄-alkenyl, wherein the C₈-C₂₄-alkenyl can be, in aspects, mono- or poly-unsaturated.

Natural lipid moieties employed in the practice of the present disclosure can be derived from, for example, phospholipids, glycerides (such as di- or tri-glycerides), glycosylglycerides, sphingolipids, ceramides, and saturated and unsaturated sterols, isoprenoids, and other like natural lipids.

Other suitable lipid moieties may include lipophilic aromatic groups such as optionally substituted aryl or arylalkyl moieties, including for example naphthalenyl or ethylbenzyl, or lipids comprising ester functional groups including, for example, sterol esters and wax esters.

In aspects, the one or more PEGylated lipids are selected from a PEG-modified phosphatidylethanolamine, a PEG-modified phosphatidic acid, a PEG-modified ceramide, a PEG-modified dialkylamine, a PEG-modified diacylglycerol, a PEG-modified dialkylglycerol, and any combinations thereof. In aspects, the PEGylated lipids comprise a PEG-modified sterol. In aspects, the PEGylated lipids comprise PEG-modified cholesterol. In aspects, the PEGylated lipid is a PEG-modified ceramide. In aspects, the PEG-modified ceramine is selected from N-octanoyl-sphingosine-1-{succinyl[methoxy(polyethylene glycol)]} and N-palmitoyl-sphingosine-1-{succinyl[methoxy(polyethylene glycol)]}, and any combination thereof.

In aspects, the PEGylated lipids are PEG-modified phospholipids, wherein the phospholipid is selected from 1,2-dilinoleoyl-sn-glycero-3-phosphocholine (DLPC), 1,2-dimyristoyl-sn-glycero-phosphocholine (DMPC), 1,2-dioleoyl-sn-glycero-3-phosphocholine (DOPC), 1,2-dipalmitoyl-sn-glycero-3-phosphocholine (DPPC), 1,2-distearoyl-sn-glycero-3-phosphocholine (DSPC), 1,2-diundecanoyl-sn-glycero-phosphocholine (DUPC), 1-palmitoyl-2-oleoyl-sn-glycero-3-phosphocholine (POPC), 1,2-di-O-octadecenyl-sn-glycero-3-phosphocholine (18:0 Diether PC), 1-oleoyl-2-cholesterylhemisuccinoyl-sn-glycero-3-phosphocholine (OChemsPC), 1-hexadecyl-sn-glycero-3-phosphocholine (C 16 Lyso PC), 1,2-dilinolenoyl-sn-glycero-3-phosphocholine, 1,2-diarachidonoyl-sn-glycero-3-phosphocholine, 1,2-didocosahexaenoyl-sn-glycero-3-phosphocholine, 1,2-dioleoyl-sn-glycero-3-phosphoethanolamine (DOPE), 1,2-dipalmitoyl-sn-glycero-3-phosphoethanolamine (DPPE), 1,2-diphytanoyl-sn-glycero-3-phosphoethanolamine (ME 16.0 PE), 1,2-distearoyl-sn-glycero-3-phosphoethanolamine, 1,2-dilinoleoyl-sn-glycero-3-phosphoethanolamine, 1,2-dilinolenoyl-sn-glycero-3-phosphoethanolamine, 1,2-diarachidonoyl-sn-glycero-3-phosphoethanolamine, 1,2-didocosahexaenoyl-sn-glycero-3-phosphoethanolamine, 1,2-dioleoyl-sn-glycero-3-phospho-rac-(1-glycerol) sodium salt (DOPG), sphingomyelin, and mixtures thereof. In aspects, the phospholipid is DOPE.

In aspects, the one or more PEGylated lipids comprise a PEG-modified phosphatidylethanol. In aspects, the PEGylated lipid is a PEG-modified phosphatidylethanol selected from PEG-modified DMPE (DMPE-PEG), PEG-modified DSPE (DSPE-PEG), PEG-modified DPPE (DPPE-PEG), and PEG-modified DOPE (DOPE-PEG).

In aspects, the PEGylated lipid is selected from dimyristoylglycerol-polyethylene glycol (DMG-PEG), distearoylglycerol-polyethylene glycol (DSG-PEG), dipalmitoylglycerol-polyethylene glycol (DPG-PEG), and dioleoylglycerol-polyethylene glycol (DOG-PEG). In aspects, the PEG lipid is DMG-PEG.

### Representative Examples

Non-limiting delivery vehicle combinations are described below. As previously described, the unit “mol %” or “molar percentage” refers to the number of moles of a particular component of the delivery vehicle composition divided by the total number of moles of all components in the delivery vehicle composition, times 100%.

In aspects, the methods may be used to de-formulate a delivery vehicle composition comprising about 30 mol % to about 45 mol % of the cationic component; about 5 mol % to about 15 mol % of the anionic/zwitterionic component, about 40 mol % to about 60 mol % of the neutral lipid compound, and about 1 mol % to about 5 mol % of the shielding component. In aspects, the methods may be used to de-formulate a delivery vehicle composition comprising about 35 mol % to about 40 mol % of the cationic component; about 8 mol % to about 12 mol % of the anionic/zwitterionic component, about 45 mol % to about 50 mol % of the neutral lipid compound, and about 1 mol % to about 3 mol % of the shielding component. In aspects, the shielding component is DMG-PEG-2000. In aspects, the methods may be used to de-formulate a delivery vehicle composition comprising Formula F2, as shown in Table 2, below. In aspects, the methods may be used to de-formulate a delivery vehicle composition comprising about 38.2 mol % of Compound 140, about 11.8 mol % of DSPC, about 48.2 mol % of cholesterol, and about 1.9 mol % of DMG-PEG-2000 (“DV-140-F2”).

In aspects, the methods may be used to de-formulate a delivery vehicle composition comprising Formula F6/17, as shown in Table 2, below. In aspects, the methods may be used to de-formulate a delivery vehicle composition comprising about 51.3 mol % of Compound 140, about 9.3 mol % of DSPC, about 38.0 mol % of cholesterol, and about 1.5 mol % of DMG-PEG 2000 (“DV-140-F6/17”).

In aspects, the methods may be used to de-formulate a delivery vehicle composition comprising about 30 mol % to about 49 mol % of the cationic component; about 5 mol % to about 15 mol % of the anionic/zwitterionic component, about 30 mol % to about 55 mol % of the neutral lipid compound, and about 1 mol % to about 3 mol % of the shielding component. The anionic/zwitterionic component can be any anionic/zwitterionic component described herein (e.g., a phospholipid). In aspects, the anionic/zwitterionic component is DSPC or DOPE. The neutral lipid component can be any neutral lipid described herein (e.g., a sterol). In aspects, the neutral lipid component is cholesterol. The shielding component can be any shielding component described herein (e.g., PEGylated lipids). In aspects, the shielding component is DMG-PEG 2000. In aspects, the delivery vehicle composition comprises Form F6/12 or Form F6/15, as shown in Table 2, below. In aspects, the methods may be used to de-formulate a delivery vehicle composition comprising about 42.6 mol % of Compound 140, about 10.9 mol % of DSPC, about 44.7 mol % of cholesterol, and about 1.7 mol % of DMG-PEG 2000 (“DV-140-F6/12”). In aspects, the methods may be used to de-formulate a delivery vehicle composition comprising about 48.1 mol % of Compound 140, about 9.9 mol % of DSPC, about 40.4 mol % of cholesterol, and about 1.6 mol % of DMG-PEG 2000 (“DV-140-F6/15”).

The cationic component can be any cationic component described herein, such as any of the compounds of Formula (I) (e.g., the compounds listed in Table 1, such as compound 140, 146, 151, 152, 160, 161, and 162). In aspects, the cationic compound is Compound 140. The anionic/zwitterionic component can be any anionic/zwitterionic component described herein (e.g., a phospholipid). In aspects, the anionic/zwitterionic component is DSPC or DOPE. The neutral lipid component can be any neutral lipid described herein (e.g., a sterol). In aspects, the neutral lipid component is cholesterol. The shielding component can be any shielding component described herein (e.g., PEGylated lipids). In aspects, the shielding component is DMG-PEG 2000. In aspects, the methods may be used to de-formulate a delivery vehicle composition comprising F6.1 or F6.2, as shown in Table 2, below. In aspects, the methods may be used to de-formulate a delivery vehicle composition comprising about 44.4 mol % of Compound 140, about 10.6 mol % of DSPC, about 43.3 mol % of cholesterol, and about 1.7 mol % of DMG-PEG 2000 (“DV-140-F6.1”). In aspects, the methods may be used to de-formulate a delivery vehicle composition comprising about 44.4 mol % of Compound 140, about 10.6 mol % of DSPC, about 43.4 mol % of cholesterol, and about 1.7 mol % of DMG-PEG 2000 (“DV-140-F6.2”).

In aspects, the methods may be used to de-formulate a delivery vehicle composition comprising F6.3, as shown in Table 2, below. In aspects, the methods may be used to de-formulate a delivery vehicle composition comprising about 33.1 mol % of Compound 140, about 10.5 mol % of DSPC, about 53.8 mol % of cholesterol, and about 2.5 mol % of DMG-PEG 2000 (“DV-140-F6.1”).

TABLE 2
Delivery Vehicle (DV) Compositions

| Molecular | | Anionic or | Non-cationic | |
|---|---|---|---|---|
| Percentages | Cationic | Zwitterionic | lipid | Shielding |
| (mol %) | component | component | component | component |
| F1A | 99.1 | 0 | 0 | 0.9 |
| F2A | 17.9 | 16.4 | 62.9 | 2.8 |
| F3A | 32.9 | 13.4 | 51.7 | 2.0 |
| F4A | 17.1 | 0 | 80.2 | 2.7 |
| F5A | 42.3 | 53.3 | 0 | 4.4 |
| F6A | 38.0 | 0 | 59.7 | 2.3 |
| F1 | 21.4 | 15.7 | 60.3 | 2.7 |
| F2 | 38.2 | 11.8 | 48.2 | 1.9 |
| F3 | 36.0 | 10.0 | 51.7 | 2.4 |
| F4 | 30.2 | 29.6 | 39.5 | 0.7 |
| F5 | 32.0 | 16.7 | 48.7 | 2.6 |
| F6/12 | 42.6 | 10.9 | 44.7 | 1.7 |
| F6/15 | 48.1 | 9.9 | 40.4 | 1.6 |
| F6/17 | 51.3 | 9.3 | 38.0 | 1.5 |
| F6.1 | 44.4 | 10.6 | 43.3 | 1.7 |
| F6.2 | 44.4 | 10.6 | 43.4 | 1.7 |
| F6.3 | 33.1 | 10.5 | 53.8 | 2.5 |

In aspects, the methods may be used to de-formulate a delivery vehicle composition comprising F6.1, F6.2, or F6.3. In aspects, the methods may be used to de-formulate a delivery vehicle composition comprising FIA, F2A, F3A, F4A, F5A, F6A, F1, F2, F3, F4, F5, F6/12, F6/15, or F6/17.

In aspects, the disclosure relates to a method for de-formulation of a delivery vehicle complex comprising: (1) a delivery vehicle composition, as previously described herein, and (2) a polyanionic compound (or cargo). In aspects, the delivery vehicle composition complexes with one polyanionic compound (e.g., one RNA). In aspects, the delivery vehicle composition complexes with two different polyanionic compound (e.g., two different RNAs or an RNA and a DNA). In aspects, the delivery vehicle composition complexes with three or more different polyanionic compounds (e.g., 3, 4, or 5 different RNAs).

The delivery vehicle complexes described herein may be characterized by the relative mass ratio of one of the components of the delivery vehicle composition to the cargo (e.g., a polyanionic compound) in the complex. Mass ratios of the components in the delivery vehicle complex can be readily calculated based upon the known concentrations and volumes of stock solutions of each component used in preparing the complex. Moreover, if non-anionic cargoes are present in the delivery vehicle complex, mass ratios may provide a more accurate representation of the relative amounts of delivery vehicle components to the overall cargo than cation:anion charge ratios, which do not account for non-anionic material. Specifically, the mass ratio of a component refers to the ratio of the mass of this particular component in the system to the mass of the “cargo” in the system. “Cargo” may refer to the total polyanionic compound(s) present in the system. In one example, the polyanionic compound(s) may refer to nucleic acid(s). In one example, the polyanionic compound(s) refer to mRNA(s) encoding at least one protein.

In aspects, the disclosed methods may be used to de-formulate a delivery vehicle complex comprising Compound 140 at a mass ratio of about 12:1 with the nucleic acid, DSPC at a mass ratio of about 2.7:1 with the nucleic acid, cholesterol at a mass ratio of about 5.4:1 with the nucleic acid, and DMG-PEG 2000 at a mass ratio of about 1.4 with the nucleic acid (“DV-140-F6/12”).

In aspects, the disclosed methods may be used to de-formulate a delivery vehicle complex comprising the cationic component and the polyanionic cargo at a mass ratio of about 15:1, the anionic/zwitterionic component and the polyanionic cargo at a mass ratio of about 2.7:1, the neutral lipid component and the polyanionic cargo at a mass ratio of about 5.4:1, and the shielding component and the polyanionic cargo at a mass ratio of about 1.4:1 (“Form F6/15”). In aspects, the cationic component is a compound of Formula (I), the anionic/zwitterionic component is a phospholipid, the neutral lipid component is cholesterol, and the shielding component is a PEGylated lipid. In aspects, the polyanionic cargo is a nucleic acid, such as RNA. In aspects, the delivery vehicle complex comprises Compound 140 at a mass ratio of about 15:1 with the nucleic acid, DSPC at a mass ratio of about 2.7:1 with the nucleic acid, cholesterol at a mass ratio of about 5.4:1 with the nucleic acid, and DMG-PEG 2000 at a mass ratio of about 1.4 with the nucleic acid (“DV-140-F6/15”).

In aspects, the disclosed methods may be used to de-formulate a delivery vehicle complex comprising the cationic component and the polyanionic cargo at a mass ratio of about 13:1, the anionic/zwitterionic component and the polyanionic cargo at a mass ratio of about 2.7:1, the neutral lipid component and the polyanionic cargo at a mass ratio of about 5.4:1, and the shielding component and the polyanionic cargo at a mass ratio of about 1.4:1 (“F6.1”). In aspects, the cationic component is a compound of Formula (I), the anionic/zwitterionic component is a phospholipid, the neutral lipid component is cholesterol, and the shielding component is a PEGylated lipid. In aspects, the polyanionic cargo is a nucleic acid, such as RNA. In aspects, the delivery vehicle complex comprises Compound 140 at a mass ratio of about 13:1 with the nucleic acid, DSPC at a mass ratio of about 2.7:1 with the nucleic acid, cholesterol at a mass ratio of about 5.4:1 with the nucleic acid, and DMG-PEG 2000 at a mass ratio of about 1.4 with the nucleic acid (“DV-140-F6.1”).

In aspects, the disclosed methods may be used to de-formulate a delivery vehicle complex comprising the cationic component and the polyanionic cargo at a mass ratio of about 19:1, the anionic/zwitterionic component and the polyanionic cargo at a mass ratio of about 4.0:1, the neutral lipid component and the polyanionic cargo at a mass ratio of about 8.1:1, and the shielding component and the polyanionic cargo at a mass ratio of about 2.1:1 (“F6.2”). In aspects, the cationic component is a compound of Formula (I), the anionic/zwitterionic component is a phospholipid, the neutral lipid component is cholesterol, and the shielding component is a PEGylated lipid. In aspects, the polyanionic cargo is a nucleic acid, such as RNA. In aspects, the delivery vehicle complex comprises Compound 140 at a mass ratio of about 19:1 with the nucleic acid, DSPC at a mass ratio of about 4.0:1 with the nucleic acid, cholesterol at a mass ratio of about 8.1:1 with the nucleic acid, and DMG-PEG 2000 at a mass ratio of about 2.1 with the nucleic acid (“DV-140-F6.2”).

In aspects, the disclosed methods may be used to de-formulate a delivery vehicle complex comprising the cationic component and the polyanionic cargo at a mass ratio of about 9.7, the anionic/zwitterionic component and the polyanionic cargo at a mass ratio of about 2.7:1, the neutral lipid component and the polyanionic cargo at a mass ratio of about 6.7:1, and the shielding component and the polyanionic cargo at a mass ratio of about 2.1:1 (“F6.3”). In aspects, the cationic component is a compound of Formula (I), the anionic/zwitterionic component is a phospholipid, the neutral lipid component is cholesterol, and the shielding component is a PEGylated lipid. In aspects, the polyanionic cargo is a nucleic acid, such as RNA. In aspects, the disclosed methods may be used to deformulate a delivery vehicle complex comprising Compound 140 at a mass ratio of about 9.7:1 with the nucleic acid, DSPC at a mass ratio of about 2.7:1 with the nucleic acid, cholesterol at a mass ratio of about 6.7:1 with the nucleic acid, and DMG-PEG 2000 at a mass ratio of about 2.1 with the nucleic acid (“DV-140-F6.3”).

In one non-limiting example, the mRNA-based therapeutic composition may comprise the first isolated mRNA, second isolated mRNA and/or third isolated mRNA at least partially encapsulated by a delivery vehicle molecule that has a formulation that may be, but not limited to, poly(lactic-co-glycolic acid) (PLGA) microspheres, lipidoids, lipoplex, liposome, polymers, carbohydrates (including simple sugars), cationic lipids, and combinations thereof.

In one aspect, the disclosed methods may be used to de-formulate a delivery vehicle molecule formulation comprising at least one lipid. The lipid may be selected from, but is not limited to, DLin-DMA, DLin-K-DMA, 98N12-5, C12-200, DLin-MC3-DMA, DLin-KC2-DMA, DODMA, PLGA, PEG, PEG-DMG, and PEGylated lipids. In another aspect, the lipid may be a cationic lipid such as, but not limited to, DLin-DMA, DLin-D-DMA, DLin-MC3-DMA, DLin-KC2-DMA, and DODMA.

In one aspect, the disclosed methods may be used to de-formulate a delivery vehicle molecule having a geometry of a nanoparticle. The delivery vehicle may be, for example, an amino lipidated peptide that may include tertiary amino lipidated cationic peptides, such as any of those described in PCT application, PCT/US19/53661, titled “Lipid Nanoparticle Formulations Comprising Lipidated Cationic Peptide Compounds for Nucleic Acid Delivery”, filed on Sep. 27, 2019, and in PCT/US19/53655, titled “Tertiary Amino Lipidated Cationic Peptides for Nucleic Acid Delivery” filed on Sep. 27, 2019, the contents of each of which are incorporated herein by reference in their entirety. The nanoparticle delivery vehicle may comprise additional lipids/components. For example, the amino lipidated peptides can include one or more phospholipids, e.g., MSPC or DSPC. The lipid composition can also comprise a quaternary amine compound such as DOTAP. In aspects, the delivery vehicle has a particle size less than or equal to about 200 nm.

The disclosed methods may be used to de-formulate a mRNA-based therapeutic formulated using any of the delivery vehicles taught in, for example, US Publication No. US20180028688, the contents of which are incorporated herein by reference in their entirety.

Components of the delivery vehicle complex can be prepared through a variety of physical and/or chemical methods to modulate their physical, chemical, and biological properties. These may involve rapid combination of the hydroxyethyl-capped tertiary amino lipidated cationic peptoids in water or a water-miscible organic solvent with the desired polyanionic cargo compound (e.g., oligonucleotides or nucleic acids) in water or an aqueous buffer solution. These methods can include simple mixing of the components by pipetting, or microfluidic mixing processes such as those involving T-mixers, vortex mixers, or other chaotic mixing structures. In aspects, the multicomponent delivery system is prepared on a microfluidic platform.

It is to be understood that the particular process conditions for preparing the delivery vehicle complexes described herein may be adjusted or selected accordingly to provide the desired physical properties of the complexes. For example, parameters for mixing the components of the delivery system complex that may influence the final compositions may include, but are not limited to, order of mixing, temperature of mixing, mixing speed/rate, flow rate, physical dimensions of the mixing structure, concentrations of starting solutions, molar ratio of components, and solvents used.

### EXAMPLES

The presently described technology and its advantages will be better understood by reference to the following examples. These examples are provided to describe specific implementations of the present technology. By providing these specific examples, it is not intended limit the scope and spirit of the present technology.

The following examples demonstrate the effectiveness of the disclosed methods in de-formulating delivery vehicles containing nucleic acids, in particular, lipid nanoparticles which encapsulate multiple mRNA species. More particularly, the following examples demonstrate one-step methods which do not require a nucleic acid isolation (“clean-up”) step but which allow for resolution of the nucleic acids using capillary electrophoresis.

### Example 1

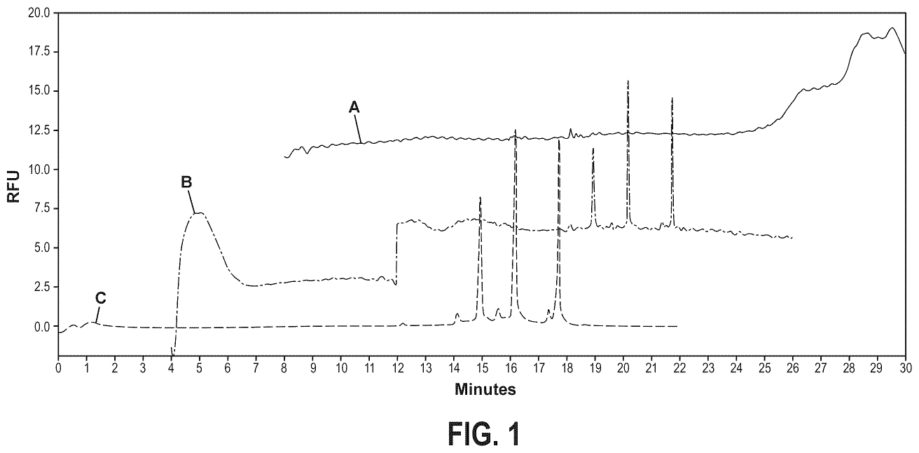

The effect of voltage vs. pressure injection and Triton X-100 concentration on the peak shape and signal resolution is shown in FIG. 1. Electropherogram trace “A”: 10 μL of a DV-140-F6.3 formulation solution (prepared as described above) containing 1 mg/mL RNA concentration (nominal) were mixed with 20 μL of 0.3% Triton X-100 in water (v/v) and 50 μL of SCIEX® formamide-containing Sample Loading Solution (SLS) (see, e.g., https://sciex.com/content/dam/SCIEX/pdf/tech-notes/biopharma/mrna-Inp-nucleic-acid-assessment.pdf). 10 μL of water were added for a total volume of 90 μL and the final concentration of Triton X-100 was approximately 0.07%. The solution was heated at 70° C. for 10 minutes and immediately placed on ice for 10 minutes. The sample was stored at 10° C. in the SCIEX® PA800 Plus refrigerated chamber. The sample was introduced into a 30-cm bare fused-silica capillary by electrokinetic injection (1 kV, 3.0 sec.) and resolved at 6 kV separation voltage at 30° C. capillary temperature. Left Y-axis corresponds to electropherogram data. Electropherogram trace “B”: 50 μL of 10% v/v Triton X-100 solution in water were added to 4 μL of the LNP solution containing 1 mg/mL RNA concentration (nominal) and mixed thoroughly. 46 μL of SLS were added for a total volume of 100 μL and the final Triton X-100 concentration of 5% v/v. The solution was heated at 70° C. for 10 minutes and cooled on ice for 10 minutes. The sample was introduced into a 30-cm bare fused-silica capillary by electrokinetic injection (1 kV, 3.0 sec.) and resolved at 6 kV separation voltage at 30° C. capillary temperature. Left Y-axis corresponds to electropherogram data. Electropherogram trace “C”: 50 μL of 10% v/v Triton X-100 solution in water were added to 4 μL of the LNP solution containing 1 mg/mL RNA concentration (nominal) and mixed thoroughly. 46 μL of SLS were added for a total volume of 100 μL and the final Triton X-100 concentration of 5% v/v. The solution was heated at 70° C. for 10 minutes and cooled on ice for 10 minutes. The sample was introduced into a 30-cm bare fused-silica capillary by pressure injection (1 psi, 10.0 sec.) and resolved at 6 kV separation voltage at 30° C. capillary temperature. Right Y-axis corresponds to electropherogram data.

### Example 2

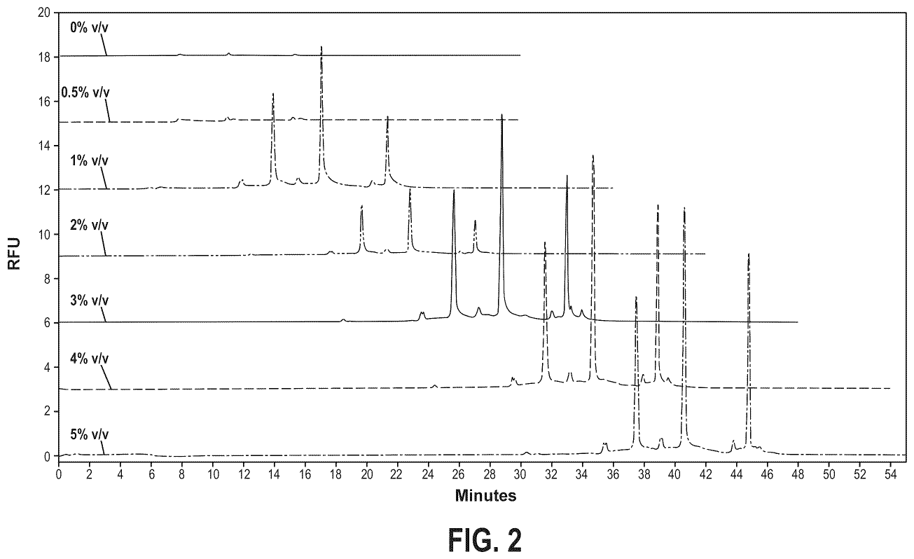

De-formulation was tested using increasing concentrations of Triton X-100. Triton X-100 concentration effects are shown in FIG. 2. Samples were assembled in accordance with the following table using the following order of addition. 4 μL of the DP were transferred to a 0.2 mL PCR tube. Triton X-100 was added, and the solution was mixed twenty times with pipetting. SLS was then added to the solution. The samples were mixed thoroughly by inversion and briefly centrifuged in the microfuge. The thermocycler was preheated to 70° C. (105° C. lid), and samples heated for 10 minutes, followed by cooling on ice for 10 minutes. 90 μL of the cooled sample was transferred to SCIEX microvial for injection. Each sample was introduced into a 50-cm bare fused-silica capillary by pressure injection (1.0 psi, 15 sec.) and resolved at 10 kV separation voltage at 30° C. capillary temperature.

| | | | Nominal | | | | |
|---|---|---|---|---|---|---|---|
| | | | Target | | Volume | | |
| | | Nominal | RNA | Volume | of 10% | | |
| | | RNA | Amount | of | v/v | Volume | |
| Sample | | Concentration | in | Material | Triton-X | of SLS | Final |
| Plate | Sample Name/ | of Sample | Sample | to Add | to Add | to Add | Volume |
| Location | Description | (μg/ul) | (μg) | (μL) | (μL) | (μL) | (μL) |
| 1 | RNA 6000 Ladder | — | — | 2.0 | — | 98.0 | 100 |
| 2 | Blank (Formulation | 0 | 0 | 4.0 | 50.0 | 46.0 | 100 |
| | Buffer) | | | | | | |
| 3 | B00494_5% Triton | 1 | 4 | 4.0 | 50.0 | 46.0 | 100 |
| 4 | B00494_4% Triton | 1 | 4 | 4.0 | 40.0 | 56.0 | 100 |
| 5 | B00494_3% Triton | 1 | 4 | 4.0 | 30.0 | 66.0 | 100 |
| 6 | B00494_2% Triton | 1 | 4 | 4.0 | 20.0 | 76.0 | 100 |
| 7 | B00494_1% Triton | 1 | 4 | 4.0 | 10.0 | 86.0 | 100 |
| 8 | B00494_0.5% Triton | 1 | 4 | 4.0 | 5.0 | 91.0 | 100 |
| 9 | B00494_0% Triton | 1 | 4 | 4.0 | 0.0 | 96.0 | 100 |

### Example 3

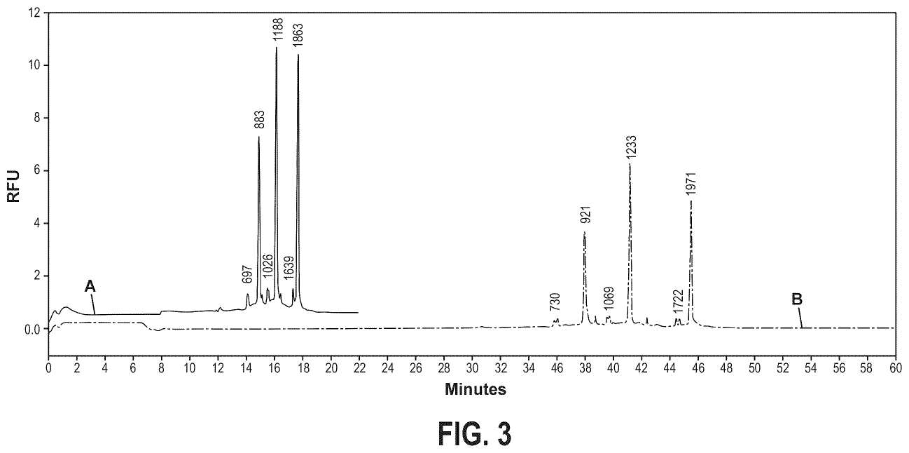

A comparison of the electropherogram traces obtained using a 30 cm and a 50 cm capillary is shown in FIG. 3. 50 μL of 10% v/v Triton X-100 solution in water were added to 4 μL of the DV solution containing 1 mg/mL RNA. The solution was mixed thoroughly and supplemented with 46 μL of SLS for the final Triton X-100 concentration of 5%. The solution was mixed and heated at 70° C. for 10 minutes and immediately chilled on ice for 10 minutes. The sample corresponding to Line A was introduced into a 30-cm bare fused-silica capillary by pressure injection (1 psi, 10.0 sec.) and separation was performed at 6 kV separation voltage and 30° C. capillary temperature. The sample corresponding to Line B was introduced into a 50-cm bare-fused silica capillary by pressure injection (1 psi, 15.0 sec.) and separation was performed at 10 kV separation voltage and 30° C. capillary temperature.

### Example 4

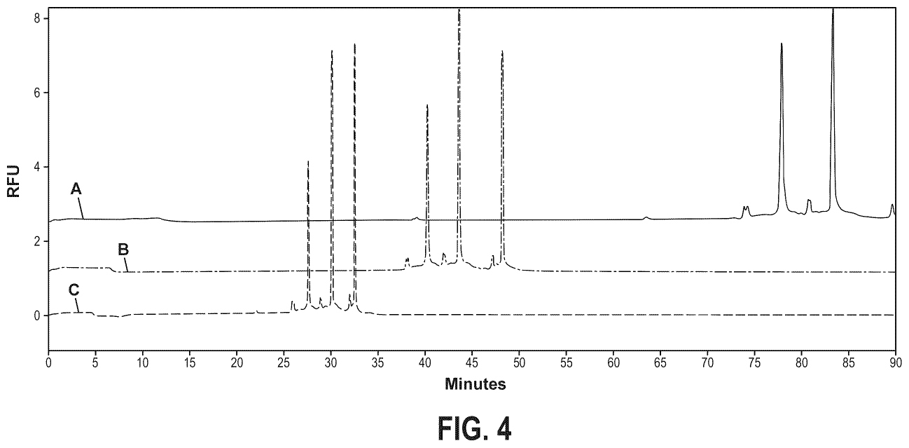

Separation voltage at 5 kV, 10 kV, and 15 kV are shown in FIG. 4. 50 μL of 10% v/v Triton X-100 solution in water were added to 4 μL of the DV solution containing 1 mg/mL RNA concentration (nominal). The solution was mixed thoroughly by pipetting and supplemented with 46 μL of SLS for a final Triton X-100 concentration of 5% v/v. The solution was mixed and heated at 70° C. for 10 minutes and immediately placed on ice for 10 minutes. The sample was introduced into a 50-cm bare fused-silica capillary using a pressure injection (1 psi, 15.0 sec.) and separation was performed at 30° C. capillary temperature and either 5 kV (line), 10 kV (Line B), or 15 kV (Line C) separation voltage.

### Example 5

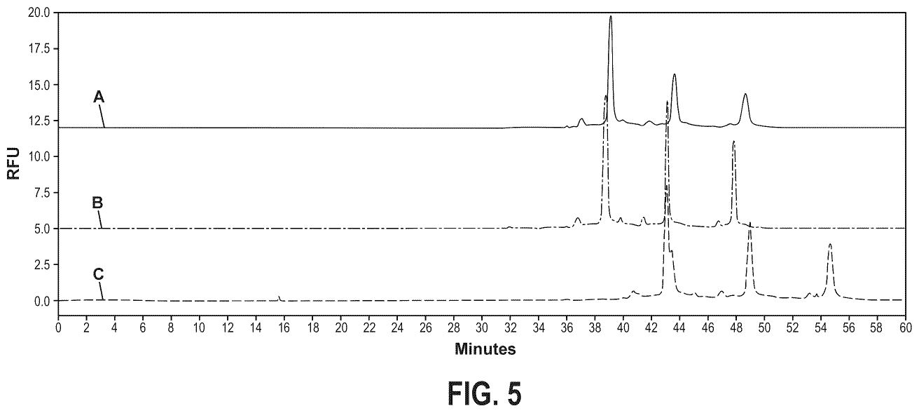

Electropherogram traces using various separation temperatures are shown in FIG. 5. 50 μL of 10% v/v Triton X-100 solution in water were added to 4 μL of the DV solution containing 1 mg/mL RNA concentration. The solution was mixed thoroughly by pipetting and supplemented with 46 μL of SLS for a final Triton X-100 concentration of 5% v/v. The solution was mixed and heated at 70° C. for 10 minutes and immediately placed on ice for 10 minutes. The sample was introduced into a 50-cm bare fused-silica capillary using a pressure injection (1 psi, 15.0 sec.) and separation was performed at 10 kV separation voltage at either 35° C. (Line A), 30° C. (Line B) or 25° C. (Line C) capillary temperature.

### Example 6

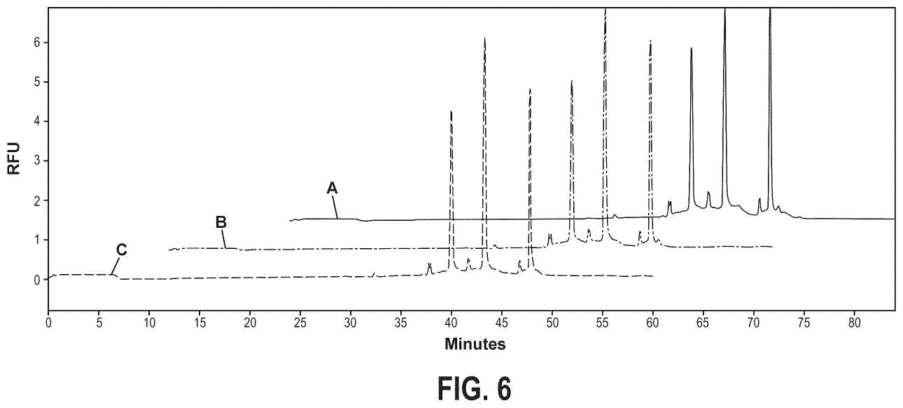

Electropherogram traces using various amounts of injected RNA are shown in FIG. 6. Increasing volume of the DV solution containing 1 mg/mL of RNA concentration (nominal) was treated with the same concentration of Triton X-100 and electrophoresed using a 50 cm capillary. 50 μL of 10% v/v Triton X-100 solution in water were added to either 10 μL (Line A), 6 μL (Line B) or 4 μL (Line C) of the DV solution containing 1 mg/mL RNA concentration (nominal). The solutions were mixed thoroughly and supplemented with SLS for the final volume of 100 μL and 5% v/v Triton X-100 final concentration. The solution was mixed and heated at 70° C. for 10 minutes and immediately placed on ice for 10 minutes. Each sample was introduced into a 50-cm bare fused-silica capillary by pressure injection (1.0 psi, 15 sec.) and resolved at 10 kV separation voltage at 30° C. capillary temperature.

### Example 7

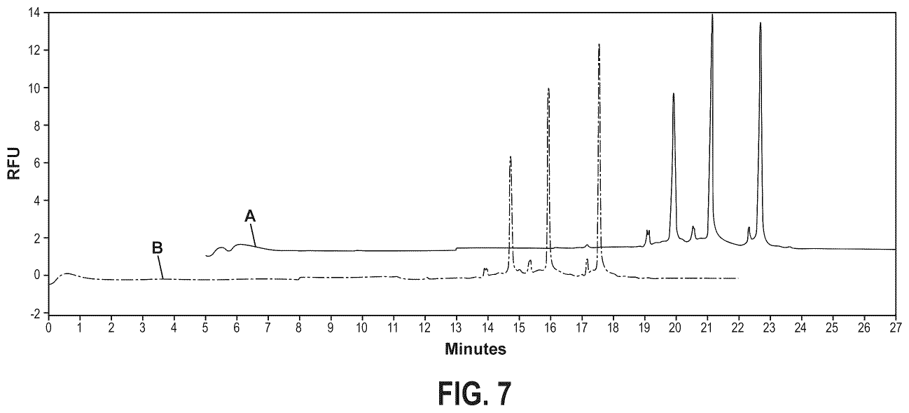

Electrophoresis of the sample obtained by treating 4 μg of DV sample with 5% Triton X-100 in SLS yield a high-quality electropherogram as shown in FIG. 7, line A. 50 μL of 10% v/v Triton X-100 solution in water were added to 4 μL of the DV solution containing 1 mg/mL RNA concentration (nominal). The solution was thoroughly mixed and supplemented with 46 μL of SLS for the final Triton X-100 concentration of 5% v/v. The solution was mixed and heated at 70° C. for 10 minutes and placed on ice for 10 minutes. Pressure injection (1 psi, 10.0 sec.) was used to inject the samples into a 30-cm bare fused-silica capillary and electrophoresis was performed at 30° C. and 6 kV (FIG. 7, line A). The Right Y-axis corresponds to electropherogram data. FIG. 7, line B shows an electropherogram trace generated using 5 ng/μL of drug substance (DS) material (i.e., not encapsulated in a DV) was mixed with 95 μL of SLS, heated at 70° C. for 10 minutes and cooled on ice for ten minutes. The sample was injected electrokinetically (1.0 kV, 3.0 sec.) into a 30-cm bare fused-silica capillary and electrophoresed at 6 kV and 30° C. (FIG. 7, line B). Electropherograms of high quality were obtained in both cases. Left Y-axis corresponds to electropherogram data.

### Example 8

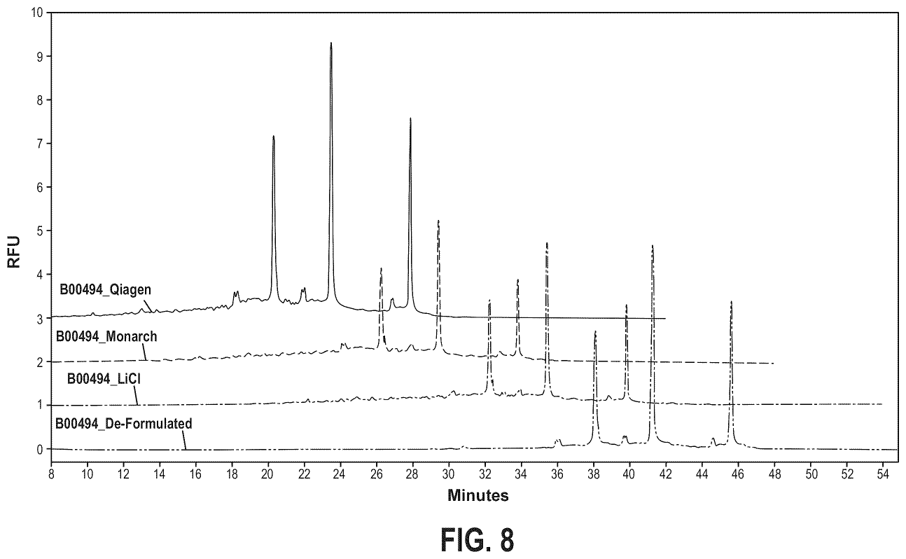

Example 8 shows electropherogram tracings of de-formulated lipid nanoparticles using different methods. FIG. 8, line A. 50 μL of 10% v/v Triton X-100 solution in water were added to 4 μL of LNP drug product containing 1 mg/mL RNA concentration. The solution was mixed thoroughly by pipetting and supplemented with 46 μL of SLS for a final Triton X-100 concentration of 5% v/v. The solution was mixed and heated at 70° C. for 10 minutes and immediately placed on ice for 10 minutes. The sample was introduced into a 50-cm bare fused-silica capillary using a pressure injection (1 psi, 15.0 sec.) and separation was performed at 10 kV separation voltage at 30° C. (FIG. 8, line A). FIG. 8, line B: 4 μL of LNP drug product containing 1 mg/mL RNA concentration was diluted to 100 μL with Teknova formulation buffer (3S1250) (20 mM Citrate, 300 mM Sucrose, pH 5.5) and de-formulated with 100 μL of 10% TRITON-X100 (5% final). 200 μL of 8M LiCl were added to the de-formulated drug product and the solution was incubated at −25° C. overnight. The sample was centrifuged at 15,000 rpm 4° C. for 40 min to precipitate RNA. The RNA pellet was washed with 900 μL of 80% ethanol, spun down as described above, and allowed to dry. The purified RNA was dissolved in 30 μL of nuclease-free water (Invitrogen, AM9937). 3 μL of the RNA solution were mixed with 97 μL of SLS and the sample was injected into a 50 cm bare-fused silica capillary using electrokinetic injection (1 kV, 5.0 sec.). The RNA was electrophoresed at 10 kV 30° C. (FIG. 8, line B). FIG. 8, line C: 4 μL of LNP drug product containing 1 mg/mL RNA concentration was diluted to 50 μL with Teknova formulation buffer and the RNA extraction was performed using the Monarch RNA Cleanup Kit (50 μg) (#T2040L) protocol established by the manufacturer. 4.5 μL of the RNA solution were mixed with 95.5 μL of SLS and the sample was injected into a 50 cm bare-fused silica capillary using electrokinetic injection (1 kV, 5.0 sec.). The RNA was electrophoresed at 10 kV 30° C. (FIG. 8, line C). FIG. 8, line D: 4 μL of LNP drug product containing 1 mg/mL RNA concentration was diluted to 100 μL with Teknova formulation buffer and the RNA extraction was performed using the Qiagen RNeasy MinElute Cleanup Kit (50) (REF 74204, GTIN 04053228006152) protocol established by the manufacturer. 2.5 μL of the RNA solution were mixed with 97.5 μL of SLS and the sample was injected into a 50 cm bare-fused silica capillary using electrokinetic injection (1 kV, 5.0 sec.). The RNA was electrophoresed at 10 kV 30° C. (FIG. 8, line D). As evidenced by the resulting tracings, the one-step de-formulation method as disclosed herein, which does not require a clean-up step, yields a substantially similar result, as shown by the blue trace.

### Example 9

Example 9 shows electropherograms generated by electrophoresis of de-formulated drug products lipid nanoparticles containing different delivery vehicles. Each lipid nanoparticle is composed of cholesterol, PEGylated phospholipid (DMG-PEG 2000), distearoylphosphatidylcholine (DSPC), and either ionizable lipid or peptoid, which encapsulates a luciferase construct. DV1 is an MC3-based lipid (available from Moderna) containing nanoparticle comprising Dlin-MCR-MDA, DMG-PEG 2000, DSPC, and cholesterol in 12.9:1.38:2.68:5.37 mass ratio per mass unit of RNA. DV2 is composed of NTX-DV1-0292 peptoid, DMG-PEG 2000, DSPC, and cholesterol in 20:1.84:1.79:7.16 mass ratio per mass unit of RNA. DV 3 is an SM102-based lipid nanoparticle containing SM102, DMG-PEG 2000, DSPC, and cholesterol in 11:1.2:2.5:4.6 mass ratio per mass unit of RNA. DV4 is composed of NTX-DV1-0249 peptoid, DMG-PEG 2000, DSPC, and cholesterol in 20:1.84:1.79:7.16 mass ratio per mass unit of RNA. DV5 is composed of NTX-DV1-0140 peptoid, DMG-PEG 2000, DSPC, and cholesterol in 9.68:2.08:2.68:6.71 mass ratio per mass unit of RNA. Lipid nanoparticles containing each DV and luciferase RNA at 1 mg/mL were first diluted in Teknova buffer 4-fold. 50 μL of 10% v/v Triton X-100 solution in water were added to 3 μL of the dilution. The solution was mixed thoroughly by pipetting and supplemented with 47 μL of SLS for a final Triton X-100 concentration of 5% v/v. The solution was mixed and heated at 70° C. for 10 minutes and immediately placed on ice for 10 minutes. The sample was introduced into a 50-cm bare fused-silica capillary using a pressure injection (1 psi, 15.0 sec.) and separation was performed at 10 kV separation voltage at 30° C. The resulting data demonstrates that each lipid nanoparticle is effectively de-formulated using the disclosed methods and that the method is effective across a range of delivery vehicle types.

### Example 10

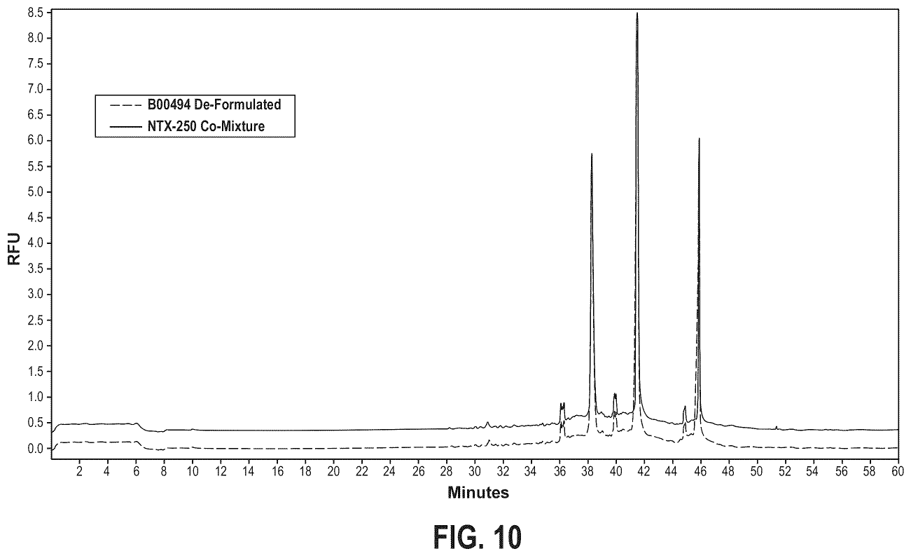

Example 10 compares de-formulation of the reference lipid nanoparticle comprising three mRNA species [encoding IL-12, Engineered Light, and HPV 16 E6-E7 fusion] (FIG. 10, line A) and a co-mixture comprising the same RNAs in water in 1:1:1 mass ratio (FIG. 10, line B). FIG. 10, line A: 50 μL of 10% v/v Triton X-100 solution in water were added to 4 μL of LNP drug product containing 1 mg/mL RNA concentration. The solution was mixed thoroughly by pipetting and supplemented with 46 μL of SLS for a final Triton X-100 concentration of 5% v/v. The solution was mixed and heated at 70° C. for 10 minutes and immediately placed on ice for 10 minutes. The sample was introduced into a 50-cm bare fused-silica capillary using a pressure injection (1 psi, 15.0 sec.) and separation was performed at 10 kV separation voltage at 30° C. (FIG. 10, line A). FIG. 10, line B: The NTX-250 co-mixture in water was diluted in SLS 50-fold to the final RNA concentration of 2 ng/μL. The sample was heated at 70° C. for 10 minutes and cooled on ice for ten minutes. The sample was injected electrokinetically (1.0 kV, 3.0 sec.) into a 30-cm bare fused-silica capillary and electrophoresed at 6 kV and 30° C. (FIG. 10, line B). The resulting tracings illustrate that the co-mixture that has never been in contact with lipid and the de-formulated mixture have yielded very similar tracings, demonstrating the effectiveness of the disclosed method in de-formulating drug product comprising a lipid nanoparticle and nucleic acid.

### Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method for analyzing a nucleic acid encapsulated in a delivery vehicle, comprising
a. solubilizing said LNP with a nonionic surfactant to form an analyte sample, said nonionic surfactant comprising from about 1% to about 10% v/v of said analyte sample;
b. introducing said analyte sample into a capillary; and
c. detecting said nucleic acid via capillary electrophoresis (CE).

### Example 2

The method of example 1, wherein said nucleic acid is selected from a single stranded (ssRNA), a double stranded RNA (dsRNA), a viral RNA, a retroviral RNA replicon RNA, a small interfering RNA (siRNA), an antisense RNA (asRNA), a circular RNA (circRNA), a ribozyme, an aptamer, a riboswitche, an immunostimulating/immunostimulatory RNA, a transfer RNA (tRNA), a ribosomal RNA (rRNA), a small nuclear RNA (snRNA), a small nucleolar RNA (snoRNA), a microRNA (miRNA), a Piwi-interacting RNA (piRNA), and combinations thereof.

### Example 3

The method of example 1 or 2, wherein said nucleic acid is mRNA.

### Example 4

The method of any preceding example, wherein said nucleic acid comprises at least one, or at least two, or at least three, or at least four, or at least five nucleic acid species.

### Example 5

The method of any preceding example claim, wherein said nucleic acid comprises more than five nucleic acid species.

### Example 6

The method of any preceding example, wherein said nucleic acid is from about 1000 to about 10,000 kb, or from about 2000 kb to about 8000 kb, or from about 4000 kb to about 6000 kb.

### Example 7

The method of any preceding example, wherein said nucleic acid is present in said analyte sample in an amount of from about 1 to about 25 μg, or from about 2 to about 20 μg, or from about 3 to about 15 μg, or from about 4 to about 10 μg or from about 5 to about 12 μg.

### Example 8

The method of any preceding example, wherein said nonionic surfactant is present at a concentration of from about 1% to about 8%, or from about 4% to about 6%.

### Example 9

The method of any preceding example, wherein said nonionic surfactant is Triton X-100.

### Example 10

The method of any preceding example, wherein said delivery vehicle is a peptoid-based.

### Example 11

The method of any preceding example, wherein said delivery vehicle is a lipid nanoparticle (LNP)

### Example 12

The method of any preceding example, wherein said delivery vehicle comprises a hydroxyethyl-capped tertiary amino lipidated cationic peptoid.

### Example 13

The method of any preceding example, wherein said delivery vehicle comprises an anionic/zwitterionic component.

### Example 14

The method of any preceding example, wherein said delivery vehicle comprises a PEGylated lipid.

### Example 15

The method of any preceding example, wherein said delivery vehicle comprises a neutral lipid component.

### Example 16

The method of any preceding example, wherein said delivery vehicle comprises a sterol.

### Example 17

The method of any preceding example, wherein said delivery vehicle comprises a shielding component.

### Example 18

The method of any preceding example, wherein said delivery vehicle comprises DLin-MC3-DMA.

### Example 19

The method of any preceding example, wherein said delivery vehicle comprises SM-102.

### Example 20

The method of any preceding example, wherein said analyte sample further comprises formamide.

### Example 21

The method of any preceding example, wherein said analyte sample is heated to a temperature of about 70° C. prior to the detecting of step (c).

### Example 22

The method of any preceding example, wherein said analyte sample is cooled prior to the detecting of step (c).

### Example 23

The method of any preceding example, wherein said analyte sample is introduced into said capillary via pressure injection.

### Example 24

The method of any preceding example, wherein said analyte sample is introduced into said capillary via electrokinetic injection.

### Example 25

The method of any preceding example, wherein said analyte sample is subjected to a separation voltage of from about 5 to about 15 kV, or about 10 kV and wherein said capillary has a length of about 50 cm.

### Example 26

The method of any preceding example, wherein said analyte sample is subjected to a separation voltage of from about 2 to about 15 kV, or about 6 kV and wherein said capillary has a length of about 30 cm.

### Example 27

The method of any preceding example, wherein said capillary has a temperature of from about 25° C. to about 35° C., or about 30° C.

### Example 28

The method of any preceding example, wherein said capillary has a length of from about 30 cm to about 80 cm, or about 50 cm.

### Example 29

The method of any preceding example, wherein data is collected at a rate of about 8 Hz (data point per second).

### Example 30

The method of any preceding example, wherein said detecting is performed using light induced fluorescence with SYBR™ Green II RNA Gel Stain (laser-induced fluorescence detection).

All features disclosed in the specification, including the claims, abstracts, and drawings, and all the steps in any method or process disclosed, may be combined in any combination, except combinations where at least of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

It will be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

The presently described technology is described in such full, clear, concise and exact terms as to enable any person skilled in the art to which it pertains, to practice the same. It is to be understood that the disclosure describes preferred aspects of the invention and that modifications may be made therein without departing from the spirit or scope of the invention.

1. A method for analyzing a nucleic acid encapsulated in a delivery vehicle, comprising
a. solubilizing said delivery vehicle with a nonionic surfactant to form an analyte sample, said nonionic surfactant comprising from about 1% to about 10% v/v of said analyte sample;
b. introducing said analyte sample into a capillary; and
c. detecting said nucleic acid via capillary electrophoresis (CE).

2. The method of claim 1, wherein said nucleic acid is selected from a single stranded (ssRNA), a double stranded RNA (dsRNA), a viral RNA, a retroviral RNA replicon RNA, a small interfering RNA (siRNA), an antisense RNA (asRNA), a circular RNA (circRNA), a ribozyme, an aptamer, a riboswitche, an immunostimulating/immunostimulatory RNA, a transfer RNA (tRNA), a ribosomal RNA (rRNA), a small nuclear RNA (snRNA), a small nucleolar RNA (snoRNA), a microRNA (miRNA), a Piwi-interacting RNA (piRNA), and combinations thereof.

3. The method of claim 1, wherein said nucleic acid is mRNA.

4. The method of claim 1, wherein said nucleic acid comprises at least one, or at least two, or at least three, or at least four, or at least five nucleic acid species.

5. The method of claim 1, wherein said nucleic acid comprises more than five nucleic acid species.

6. The method of claim 1, wherein said nucleic acid is from about 1000 to about 10,000 kb, or from about 2000 kb to about 8000 kb, or from about 4000 kb to about 6000 kb.

7. The method of claim 1, wherein said nucleic acid is present in said analyte sample in an amount of from about 1 to about 25 μg, or from about 2 to about 20 μg, or from about 3 to about 15 μg, or from about 4 to about 10 μg or from about 5 to about 12 μg.

8. The method of claim 1, wherein said nonionic surfactant is present at a concentration of from about 1% to about 8%, or from about 4% to about 6%.

9. The method of claim 1, wherein said nonionic surfactant is Triton X-100.

10. The method of claim 1, wherein said delivery vehicle is a peptoid-based.

11. The method of claim 1, wherein said delivery vehicle is a lipid nanoparticle (LNP).

12. The method of claim 1, wherein said delivery vehicle comprises a hydroxyethyl-capped tertiary amino lipidated cationic peptoid.

13. The method of claim 1, wherein said delivery vehicle comprises an anionic/zwitterionic component.

14. The method of claim 1, wherein said delivery vehicle comprises a PEGylated lipid.

15. The method of claim 1, wherein said delivery vehicle comprises a neutral lipid component.

16. The method of claim 1, wherein said delivery vehicle comprises a sterol.

17. The method of claim 1, wherein said delivery vehicle comprises a shielding component.

18. The method of claim 1, wherein said delivery vehicle comprises DLin-MC3-DMA.

19. The method of claim 1, wherein said delivery vehicle comprises SM-102.

20. The method of claim 1, wherein said analyte sample further comprises formamide.

21-30. (canceled)
